(19) United States
(12) Patent Application Publication
(10) Pub. No.: US 2010/0015926 A1
(43) Pub. Date: Jan. 21, 2010

(54) SYSTEM AND METHODS TO MONITOR AND ANALYZE EVENTS ON WIRELESS DEVICES TO PREDICT WIRELESS NETWORK RESOURCE USAGE

(76) Inventor: Robert A. Luff, Wittman, MD (US)

Correspondence Address: Hanley, Flight & Zimmerman, LLC, 150 S. Wacker Dr. Suite 2100, Chicago, IL, 60606, US

(21) Appl. No.: 12/505,225

(22) Filed: Jul. 17, 2009

Related U.S. Application Data
(60) Provisional application No. 61/081,846, filed on Jul. 18, 2008.

(51) Int. Cl. H04B 17/00

(52) U.S. Cl. 455/67.13

(57) ABSTRACT

System and methods to monitor and analyze events on a wireless device to predict wireless network usage are described. An example method to predict the use of wireless network resources from usage data of wireless devices when executed receives data related to a user interaction with a wireless device in an offline mode, analyzes the received data to predict wireless network resource usage of the wireless device, and outputs information associated with the analyzed data to enable allocation of wireless network resources.

### RELATED APPLICATIONS

This application claims the benefit of U.S. Provisional Application No. 61/081,846, filed Jul. 18, 2008, the entirety of which is incorporated by reference.

### FIELD OF THE DISCLOSURE

This disclosure relates generally to the field of data collection on wireless devices and, more particularly, to a system and methods to monitor and analyze events on wireless devices to predict wireless network resource usage.

### BACKGROUND

The increasing number of wireless devices, cellular phones, smartphones, laptops, personal digital assistants, text message machines, wireless gaming machines, music players, etc. has increased the need to monitor their use for various purposes. For example, monitoring a user's interaction with a wireless device provides visibility of the types of services and applications that may interest a user. Similarly, monitoring the performance of a wireless device enables manufacturers, wireless service providers, content providers, etc. to improve their products and services. As newer classes of services, with different Quality of Service (QoS) requirements and different transmission characteristics are offered, it becomes imperative for wireless carriers to find new methods and techniques to optimally utilize limited network bandwidth without affecting the overall network QoS. Network operators typically monitor QoS levels by tracking the total bandwidth used per cell area and throughout the entire wireless network. Additionally, network operators may periodically measure network QoS levels via wireless network probes.

Typically, wireless network service providers overdesign a wireless network system to ensure an acceptable level of performance (e.g., QoS) is maintained in the critical consumer metric of ‘all circuits busy’ or slow data transfer speed. In other words, wireless network service providers ensure that if a user attempts to access the wireless network, there is an available channel, bandwidth, and/or data carrying capacity to make a call or access the network at an acceptable QoS. In addition, channels, frequencies, and/or data capacity may be held open and/or reserved to ensure a call is not dropped as a user moves from one cell area to an adjacent cell area. Because the movement of a user is unknown to a service provider, the service providers may maintain open channels or data capacity in adjacent cell areas. In designing a wireless network the wireless network providers determine areas of coverage, number of estimated users, and/or network area usage by a time of day. These determinations may then be used to determine the number of channels by base station. These assumptions may be rough estimates that may lead to relatively inefficient and/or costly extra unused capacity built into the wireless networks.

Newer wireless networks may be configured to reactively allocate network resources via dynamic channel allocation (DCA) so that the number of carrier frequencies is adaptive and dependent on the current network load. For instance, a base station controller may monitor network usage and adjust bandwidth, number of channels, and coverage area size to ensure the network maintains specified QoS levels. DCA generally requires complex adaptive algorithms that monitor current network usage to calculate the probabilities of dropped calls, network capacity limits, and QoS requirements to determine the cell areas where network resource are strained, requiring additional resources.

### BRIEF DESCRIPTION OF THE DRAWINGS

FIG. 1 is a block diagram of an example metering system to meter and collect wireless device wireless network resource usage and event information.

FIG. 2 shows a functional block diagram of an example metering, collection, and allocation system including the metering component and the collection system of FIG. 1.

FIG. 3 shows a functional block diagram of an example wireless device including the metering component of FIG. 1, applications, event log cache, an operating system, and a transmitter.

FIG. 4A shows an example communication system at a time period T1 of a wireless network operated and/or controlled by a wireless service provider including BTSs within respective cell areas.

FIG. 4B shows the example communication system of FIG. 4A at a time period T2 of the wireless network operated and/or controlled by the wireless service provider.

FIGS. 5A-5J show tables of example event logs including an event field, a first attribute field, a second attribute field, and a description field.

FIGS. 6A-6I show example wireless network resource usage reports.

FIG. 7 is a flowchart illustrating an example method for installing and configuring the metering component used with the example systems of FIGS. 1-3.

FIG. 8A is a flowchart illustrating an example method for collecting and storing event information and wireless network resource usage data on a wireless device.

FIG. 8B is a flowchart illustrating an example method for receiving, processing, and analyzing event logs from wireless devices.

FIG. 9 is a block diagram of an example processor system that may be used to execute the example methods of FIGS. 7, 8A, and 8B and/or the example system described herein.

### DETAILED DESCRIPTION

Although the following describes example system and methods including, among other components, software and/or firmware executed on hardware, it should be noted that these examples are merely illustrative and should not be considered as limiting. For example, it is contemplated that any or all of the hardware, software, and firmware components could be embodied exclusively in hardware, exclusively in software, or in any combination of hardware and software. Accordingly, while the following describes example system and methods, the examples provided are not the only way to implement such system and methods.

The example system, methods, and/or machine readable instructions described herein may be used to monitor and analyze events on wireless devices to predict wireless network resource usage. An example method of monitoring and analyzing events on a wireless device includes collecting event metering information and/or network resource usage data associated with a wireless device, communicating the network resource usage data and/or event metering information to a collection system, and analyzing the network resource usage of events on wireless devices from a plurality of panel members. The network resource usage data and event information from each device may be processed and analyzed to determine network resource usage statistics for a sample of panel members. The sample statistics may be expanded to predict network resource usage for an entire wireless network. In addition, the statistics may be used to determine the probability a user will access the network from a time they initiate an event on their wireless device.

In the example methods described herein, wireless network resource usage may be metered by collecting event information on a wireless device, including information associated with the wireless network resources utilized by the event. The collected event information includes, for example, a timestamp of the initiation of an event, the duration of an event, instances in which the event subsequently accessed a wireless network, the target address or application accessed by the wireless device, the carrier frequency channel, the data transfer speed with a base station, and/or the duration of the data transfer. Additionally, the events and/or other data may be metered continuously, during specific time periods, and/or during random time periods.

Wireless devices may include cell phones, laptops, personal digital assistants (PDAs), audio players, wireless video players, wireless gaming machines, pocket personal computers, and/or any other wireless device(s) that may access a wireless network. Wireless devices may send and receive information wirelessly. For instance, wireless telephone service providers allow subscribers to place and receive voice telephone calls, send and receive photos, participate in text messaging, send and receive e-mail messages, browse web pages, and/or download and/or stream music broadcasts, MP3 files (including proprietary and non-proprietary digital audio/video format variations), talk radio broadcasts, news broadcasts, and various broadcast entertainment programs (e.g., sitcoms, movies, etc.). The wireless devices may include speakers to allow the user to hear analog audio signals, and/or a display, such as a liquid crystal display (LCD) screen to allow the user to view video signals.

An example system to monitor the wireless network resource usage of events within a wireless device includes a metering component to receive event information within the wireless device. Event information may include hardware and/or application information such as application type, duration of usage, network or wireless device parametric information (e.g., upload speed, download speed, network quality, volume and/or tone) and/or metadata (e.g., content title, author, date of publication, source and/or publisher information, copyright information, digital rights management information, etc.). Applications may include phoning, text messaging, instant messaging, e-mail, web browsing, media player, camera, document processing, streaming data from a server, live media, games, video recording, media editing, etc. Hardware may include the operating system, clock cycles, receiver, transmitter, and/or any other network component and/or hardware associated with the wireless device. Wireless network resource usage data and event information is referred to the following description as metered wireless device information.

The example system described herein also includes a processor that may be communicatively coupled to or included within the wireless device. The example system includes a memory communicatively coupled to the processor to store the metered wireless device information and a communication interface to communicate the metered wireless device information to a collection system (e.g., a computer, a measurement entity, server, etc.). The memory includes the event log cache, which stores metered wireless device information for different events and/or time periods. Additionally or alternatively, a processor may be configured within the collection system to receive wireless network resource usage data and event information from the metering component within one or more wireless devices. The processor may also process and store the metered wireless device information within an event log cache.

An example system to analyze wireless network resource usage of events within a wireless device includes the collection system, a memory, and an analysis system. The analysis system and the memory may be included within the collection system or, alternatively, may be communicatively coupled to the collection system. The collection system may be included within or provided by a measurement company, which may be a neutral entity that does not create and/or distribute wireless devices and/or events on wireless devices and, thus, can function as a trusted third party monitor of the wireless network resource usage and metering information of wireless devices. The collection system receives and stores metered wireless device information from a plurality of wireless devices.

The analysis system processes the metered wireless device information. Processing may include filtering the wireless network resource usage data and event information based on device type, application type, wireless network type, and/or a combination of device types, application types and/or wireless network types. The filtered wireless network resource usage data and event information for each device is processed and analyzed to determine network resource usage statistics for the sample of panel members. The sample statistics may be expanded to predict network resource usage for an entire network. In addition, the statistics may be used to determine the probability a particular user will access the network from the time they initiate an event on their wireless device. Calculating large quantities of wireless device wireless network resource usage data and event information compensates for slight differences in wireless network resource usage data between wireless devices and/or any errors from measuring wireless network resource usage.

Additionally, calculating wireless network resource usage from large quantities of data provides more accurate data than by simply attempting to measure and quantify wireless network resource usage per event type on a single wireless device or a wireless network probe using complex measuring systems. Further, the large quantities of data may be used to form heuristic usage prediction models and/or algorithms that may be used determine variations in network usage and/or variations in network usage per cell location. For example, a cell area may include an expressway that experiences morning and evening traffic congestion. During the times of traffic congestion, users included within the traffic may increase wireless device usage by accessing a network. The example reports may determine this cell area experiences a network variation that exceeds the average network usage of surrounding cell areas. The large quantity of data may be used to predict the days and/or times of the increase in network usage. Furthermore, the data may be used to detect the initial signs of increased network usage corresponding to an increase in traffic congestion.

The sample statistics and expanded network resource usage prediction data and/or other information may be used by generating reports that may be used by wireless network providers, wireless network developers, application developers, consumers etc. The reports may include specific wireless network provider information such as, for example, network usage for a single cell area over a 24 hour time period, probability one or more users and/or types of users may make a call or access the network within a certain time period based on collected data of wireless device activity, network resource usage per event type for a cell area for over a 24 hour period, wireless network efficiency over a 24 hour time period, etc. Additionally, the reports may include general wireless network data for multiple providers such as, for example, total network resource consumption for a market area, peak, average, and low wireless network resource usage for a cell area, network resource usage per event type, wireless network resource market share based on usage, network resource usage per device type, wireless network usage per application type, wireless network resource usage per demographic type, wireless network resource usage per market, etc.

In an example wireless communication system, a geographic area is divided into coverage areas called cells. Within each cell, a base station transceiver station (BTS) contains equipment for transmitting and receiving radio signals, antennas, and equipment for communicating with a base station controller (BSC). The plurality of BTSs within the cells are managed by the BSC. The BSC enables coordinated handoffs between BTSs in cases where wireless devices move between cell areas. In dynamic wireless communication systems, the BSC includes control algorithms to reactively adjust network resource allocations for BTSs in response to changing loads within each cell within the wireless network. Adjusting network resources includes allocating bandwidth and transmission power for each BTS. This has the effect of changing the size of the cell area and changing the number of traffic channels available to each transceiver. For example, if a cell area experiences a sudden increase in network usage, a BSC may increase the bandwidth at a BTS, which increases the number of frequency carrier channels, decrease the coverage area per directional antenna by lowering the transmission power, increase the number of channels by decreasing the frequency separation between channels, and/or activate reserve directional antennas and transceivers within a BTS. The BSC may be connected with other BSCs and controlled by a mobile switching center (MSC). MSCs are responsible for handling voice calls and data as well as other services (such as conference calls, FAX and circuit switched data). The MSC sets up and releases the end-to-end connection, handles mobility and hand-over requirements during the call and takes care of charging and real time pre-paid account monitoring.

Each BTS provides radio coverage to establish RF communication links to and from wireless devices. A BTS may contain more than one transceiver to enable the BTS to provide a plurality of different carrier frequencies within sectors of its corresponding cell area. For example, a BTS may contain five directional antennas with a corresponding transceiver for each antenna. In this case, each antenna covers a fifth of the cell area (i.e., each antenna covers a cell area sector having a beamwidth of 72 degrees). If the total bandwidth allocated to the BTS by the BSC is 30 MHz, the BTS may divide the bandwidth among the five antennas. As a result, each of the five transceivers included in the BTS has a bandwidth of 6 MHz. The bandwidth allocated to a transceiver is partitioned into carrier frequency channels, with a defined frequency separation between each channel. The carrier frequency channels may contain a plurality of time slots or frequency levels depending on the type of implementation. For example, in a GSM system that includes Time Division Multiple Access (TDMA) timeslots, each carrier frequency channel may contain eight or sixteen time slots. Thus, if a transceiver is allocated 6 MHz of bandwidth with a 0.200 MHz frequency separation between the carrier frequency channels, the transceiver would contain 29 carrier frequency channels. If each carrier frequency channel includes eight TDMA timeslots, the total traffic capacity of a transceiver would be 232 traffic channels. Thus, the BTS with five transceivers provides a total of 1160 traffic channels.

The timeslot within a carrier frequency channel may be referred to as a traffic channel. These traffic channels may be configured to handle digital voice communication and data transfer or, alternatively, the channels may be allocated for strictly voice or data use. Wireless network providers traditionally measure network capacity in erlangs. An erlang is a unitless metric that corresponds to the number of traffic channels used per hour. For example, a BTS with 200 traffic channels has a capacity of 200 erlangs, or 200 possible traffic channels for use over a one hour time period. If a wireless device transmits data on 1 of the 200 traffic channels for 30 minutes, 0.5 erlangs are consumed. The QoS metrics may be calculated from erlangs using equations such as, for example the Erlang B formula or the Engset formula, which calculates the probability of a call or data application being blocked due unavailable traffic channels.

The wireless network resource usage data described in the methods and system herein includes data upload and download speeds, time and duration of network access, the frequency carrier channel, type of multiplexing on the carrier channel, signal strength, signal-to-noise ratio, and BTS identification information. This monitored and collected data is analyzed by a the collection system as part of a metering service to determine network resource usage statistics and trends including fluctuations in network load during days and/or weeks, network peak and low load times, network resources utilized per wireless device type, network resources utilized by event type, and trends in network resource usage per demographic type and/or market type. Additionally, the analyzed data may determine the probability a wireless device user will access the network based on current device usage.

In the example implementation, analyzed network resource usage information may be structured into reports and provided to network service providers, wireless device manufactures, application developers, consumers etc. For example, a report may indicate that when a media player application is initiated on a wireless device in an offline mode, the user of the wireless device has a 50% probability of making a call or accessing the wireless network within 20-30 minutes. In another example, a report may indicate that a user accesses a weather website at approximately the same time every weekday morning in the same cell area. On average, the network connection may have a duration of ten seconds and communicate an average of 3.5 kilobytes of data with the weather website. A service provider may use this information to ensure a short term channel is available to this user during this time period. Further, if the user is on a train, bus, taxi, etc. and nearing the limits of the cell area, the service provider may ensure a channel is available in the cell area without a need to reserve several channels in other cell areas because the past data indicates the user will not use the network in these other cell areas.

Because the wireless device is in an offline mode, a wireless network service provider is unable to monitor the wireless device and predict future wireless network usage. Wireless network service providers may use the probability of accessing a wireless network information to install a component within wireless devices that pings the network when the media player is initiated so that the wireless network, (i.e., the BSC and the BTS) ensures there are a sufficient number of traffic channels allocated for the user to access the wireless network in 20-30 minutes. In another example, a report may indicate that wireless devices have a 5% probability of accessing the network when they are in an idle state (e.g., a state where applications are not in use). A wireless network provider may use this information to ping wireless devices to determine their current state. Wireless devices in an offline mode and/or an idle state may not respond to the ping and/or may indicate their idle status in a response. If a sufficient number of devices are in an idle state indicating a low probability they will access the network, the wireless network service provider could allocate wireless network resources to adjacent cell areas that may be experiencing higher loads.

In another example, a report may detail the erlangs utilized within a BTS over a 24 hour time period. The report may indicate that during any normal business day the number of traffic channels used within a BTS cell area is low in the mornings with an average around 15 and steadily increases until around 3:00 p.m. when 120 traffic channels are used, then slowly declines again through the end of the day. A network service provider may use this predictive information to proactively allocate network resources to ensure there are a sufficient number of traffic channels during the busiest part of the day, while shifting the network resources to other cell areas that may be busier during the morning or evening. This information may enable a wireless network provider to allocate additional network resources during this time period to ensure the network maintains QoS levels with the fluctuations in wireless network traffic.

In yet another example, a report may indicate the peak and low erlang values over the course of a year. Additionally, the report may show the highest network load over a year is 145 erlangs for a BTS identified as 6Y. The wireless network service provider may compare this to the network capacity of 6Y, which may be 500 erlangs. The wireless network service provider could reduce the number of transceivers or bandwidth in the 6Y BTS cell area, creating a more efficient communication system with less unused or underutilized resources.

In traditional communication systems, the number of channels allocated to the BTS is fixed. Since each cell must be served by enough channels to meet the peak demand capacity with a specified quality of service or a probability of call blocking, the total number of radio channels required in the system can be high. Additionally, the overall system efficiency may be low because the demands in certain cells sometimes exceed its peak traffic capacity, causing capacity shortages in some areas and excesses in other cell areas. In addition, dynamic systems can only react to network fluctuations providing opportunities for QoS reductions from increased loads before the wireless system can assess and reallocate resources. The wireless network resource usage reports described above enable wireless network service providers to proactively and intelligently predict network resource usage and subsequently adjust network resources. The adjustment may be executed by modifying BTS bandwidth, cell area, number of channels, and/or number of transceiver antennas within fixed or dynamically controlled wireless communication systems.

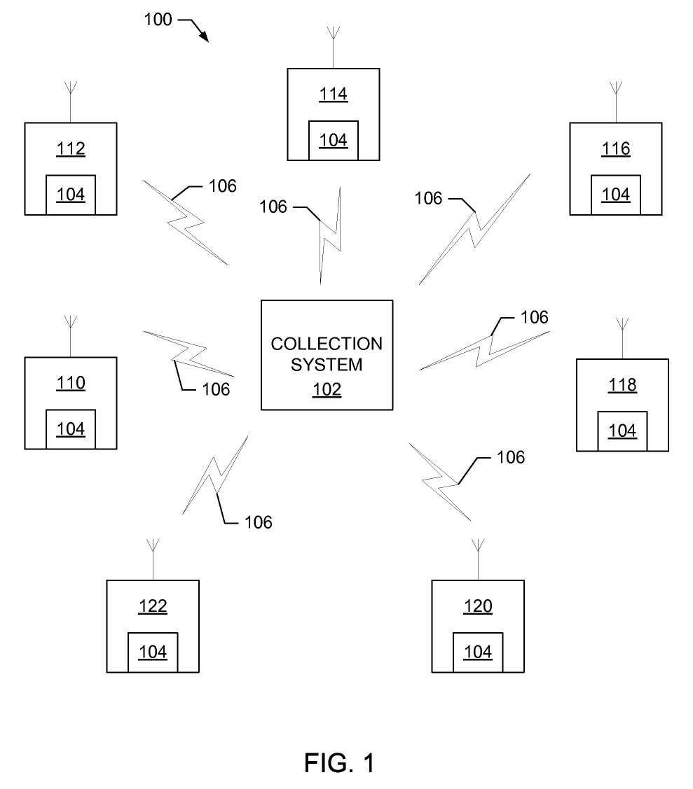

FIG. 1 is a block diagram of an example metering system 100 within which the system and methods described in greater detail below may be used to meter and collect wireless device network resource usage data and event information. The example metering system 100 includes a collection system 102 and wireless devices 110-122. The wireless devices 110-122 include a metering component 104 to collect wireless device information. The wireless devices 110-122 include, but are not limited to cell phones, laptops, personal digital assistants (PDAs), audio players, wireless video players, wireless gaming machines, pocket personal computers, and/or any other wireless device(s) that may access a wireless network. The wireless devices 110-122 can communicate with the collection system 102 via respective wireless links 106.

In the example implementation of FIG. 1, the wireless devices 110-122 use the wireless links 106 to communicate with the collection system 102. The wireless links 106 may operate on any type of wireless network and may include traffic channels of a wireless communication system. For example, the wireless network may be implemented using a circuit switched network, a paging network, and/or packet data networks including, but not limited to, AMPS, CDMA, GSM, iDEN, GPRS, ODFM, 3XRTT, 3GSM, LTE, EDGE, WiMax, etc. The metering component 104 and data transmission across the wireless links 106 may adhere to and incorporate wireless protocols and standards for voice and data communication services on networks and devices. These standards include TIA/EIA95-B (Mobile Base Station Compatibility for Wideband Spread Spectrum Cellular Systems), ANSI J-STD-008 (Personal Station-Base Station Compatibility Requirements for 1.8 to 2.0 GHz Code Division Multiple Access Personal Communication Systems), ANSI J-STD 018 (Minimum Performance Requirements for 1.8 to 2.0 GHz Code Division Multiple Access Personal Stations), TIA/EIA/IS-99 (Data Services Option Standard for Wideband Spread Spectrum Digital Cellular Systems), TIA/EIA-637-A (Short Message Service for Spread Spectrum Systems), TIA/EIA-683-A (Over-the-Air Provisioning of Mobile Stations in Spread Spectrum Systems), and various WAP documents (Wireless Application Protocol Architecture Specification, Wireless Application Environmental Specification, Wireless Telephony Application Specification, Wireless Transaction Protocol Specification, Wireless Datagram Protocol Specification, etc.).

In the example implementation, each of the wireless devices 110-122 may be in the possession of and/or be associated with a panel member. Additionally, the wireless devices 110-122 may be shared between a plurality of panel members and/or one panel member may use a plurality of the wireless devices 110-122. The metering component 104 may be activated by a panel member subscribing or registering with a metering service such as, for example, Nielsen Mobile. The collection system 102 sends the metering component 104 to the subscribing panel member to install and/or attach to a wireless device. The metering component 104 may be sent as software over one of the wireless links 106, a wired connection through a personal computer that may be transmitted via a wire or wirelessly to the wireless device, and/or sent within a memory device via the mail. Additionally or alternatively, the metering component 104 may be installed within a hardware component such as, for example, an application specific integrated circuit (ASIC), and/or installed or embedded within an operating system and/or read only memory (ROM) during manufacture of the wireless devices 110-122. In this example, a panel member registers with the metering service to activate the metering hardware and/or software within one of the wireless devices 110-122.

In the example metering system 100, the metering component 104 monitors wireless device use by a panel member and the corresponding amount of network resources utilized by the applications on the wireless device 110- 122. The metering component 104 operates in the background of the operating system, applications, and/or hardware of the wireless device 110-122. Data gathered by the metering component 104 is sent or communicated to a processor and/or an event log cache within the memory of the wireless device 110-122. In another example implementation, the metering component 104 sends or communicates the data to a personal computer having a processor and memory that processes and stores the data. The collected metered data is then transmitted via one of the remote or wide area wireless links 106 to the collection system 102, transmitted via a local wireless link (not shown) to a personal computer (not shown) connected to a network including the collection system 102, and/or transmitted via a wired link to a personal computer connected to the network.

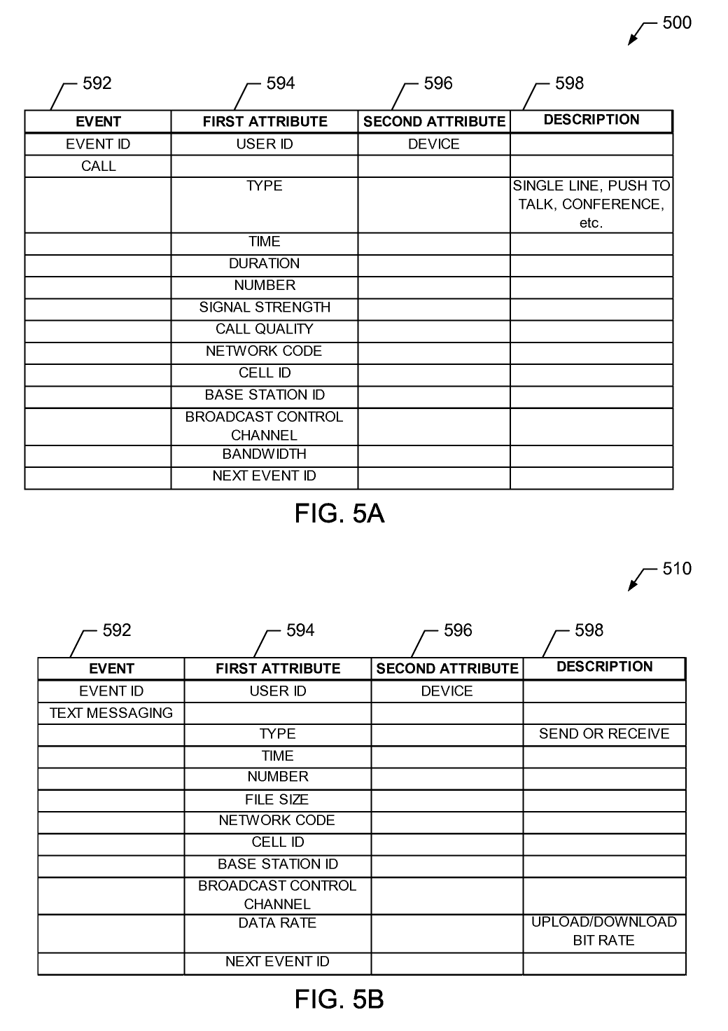

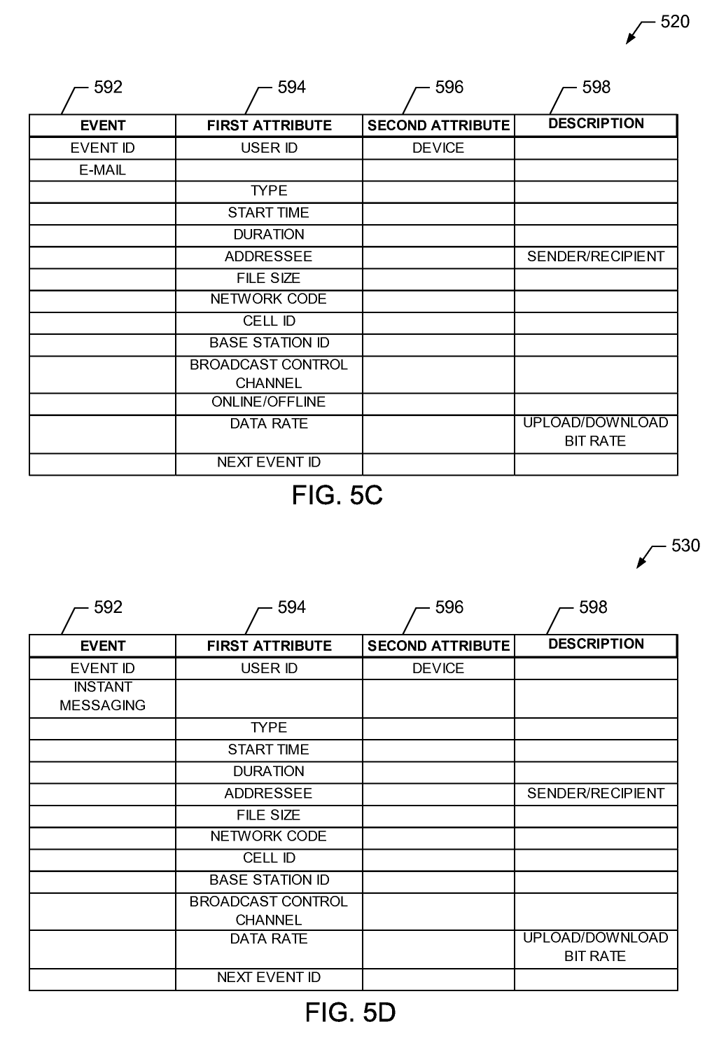

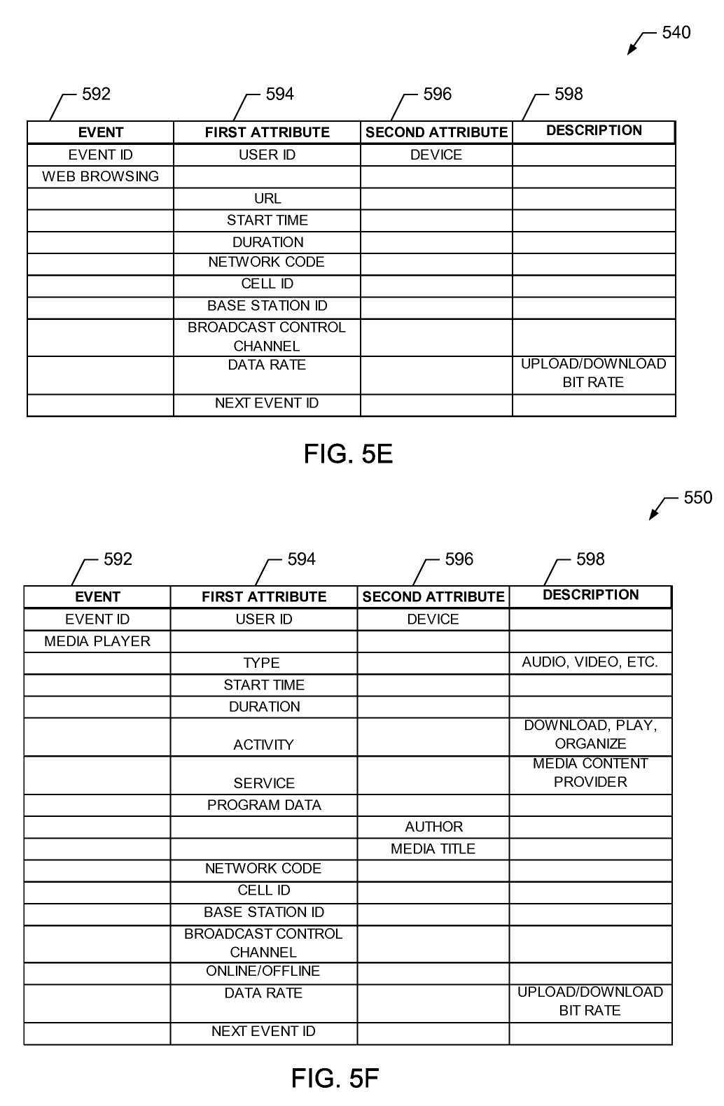

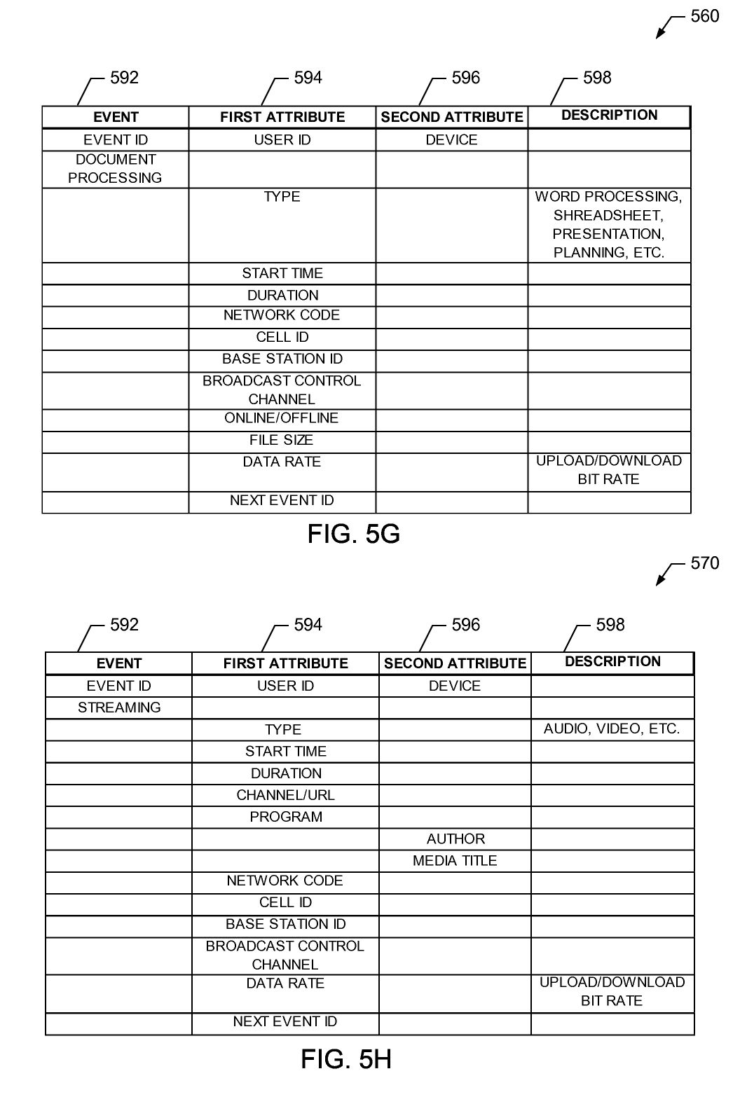

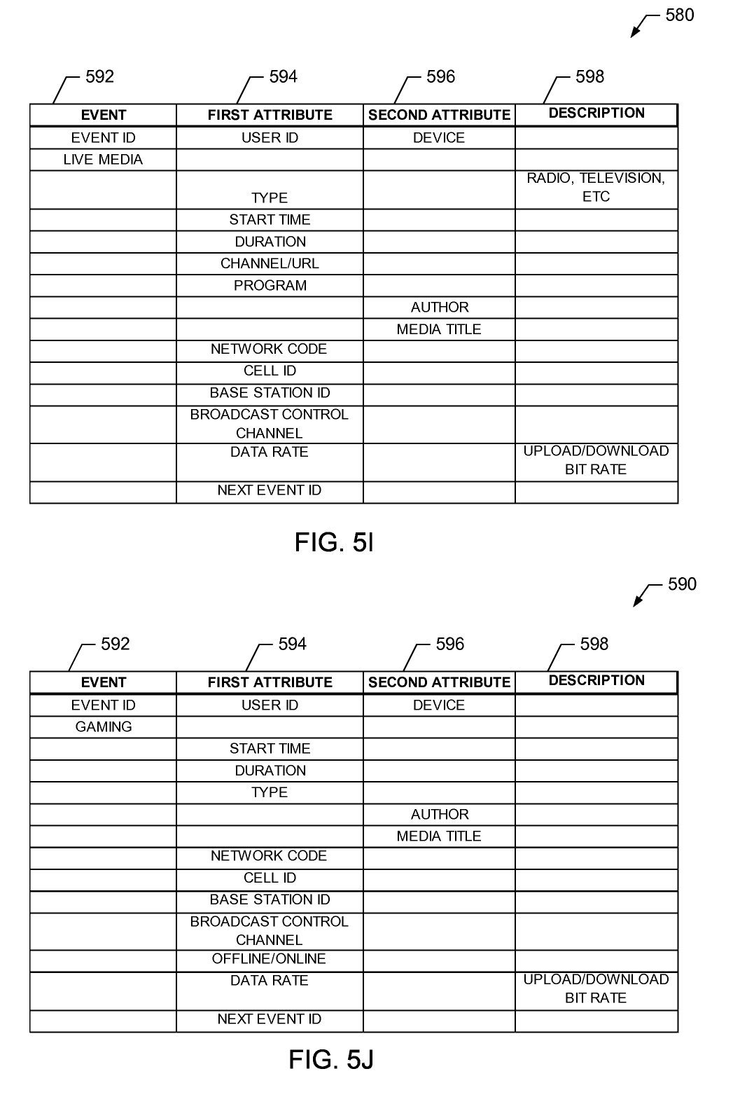

Event information may include a log of applications and/or hardware functions accessed by a panel member, wireless device parametric information, and/or network parametric (e.g., quality) information including wireless network resource usage. The metered data may be saved to the memory of the wireless devices 110-122 as part of an event log cache. The event log cache accumulates metered wireless device information for a plurality of events over one or more time periods. The metering component 104 within the wireless devices 110-122 transmits event logs from the wireless device memory to the collection system 102. The wireless devices 110- 122 may send the event logs when the event log cache is full, when the collection system 102 sends a request or query to the wireless devices 110-122, during predetermined times of a day or week, and/or when the wireless devices 110-122 are in an idle state. Example event logs are described in further detail in conjunction with FIGS. 5A-5J.

The metering component 104 may, for example, be configured to collect event information over a time period. Alternatively, the metering component 104 may be configured to continuously collect event information and the corresponding network resource usage. During the collection of event information, the metering component 104 collects the types of applications a panel member uses on a wireless device, the duration each application is used, network parametric information if any of the applications transmit or receive data, wireless device parametric information, and/or information regarding hardware functions used. After the event has been terminated, the metering component 104 stores the event information to the event log cache. Subsequently, the metering component 104 may meter and store event data collected upon the completion of each event to the event log cache. In an alternative implementation, the metering component 104 may store event information to the event log cache periodically during the operation of the event.

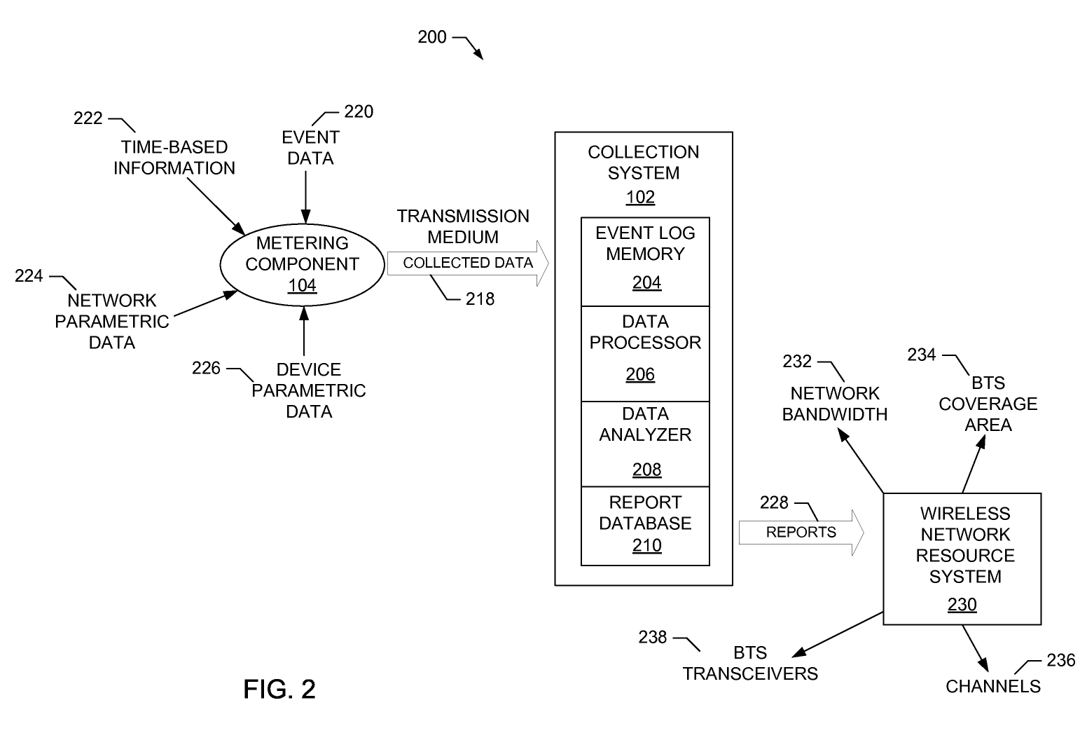

The collection system 102 within the metering system 100 is configured to receive event logs from the wireless devices 110-122 and may include a computer, a server, a measurement entity, a processor, etc. Additionally, the collection system 102 may include a memory to store the event logs, a processor to organize and filter the event logs and an analyzer to calculate statistics associated with wireless network resource usage. The collection system 102 may be part of a metering service and connected to a network including a wireless network to communicate with wireless devices wirelessly and through wired connections. For example, the collection system 102 may be located at a specific internet protocol (IP) address. The wireless devices 110-122 may access the IP address, and/or web address associated with the IP address to download the metering component 104, transmit panel member demographic information, transmit event logs, and/or register application licensing agreements. The metering component 104 may be sent from the collection system 102 to a wireless device that has registered with the metering service. The collection system 102 is described in greater detail below in conjunction with FIG. 2.

FIG. 2 shows a detailed functional block diagram of an example metering, collection, and allocation system 200, including the metering component 104, the collection system 102 of FIG. 1, and a wireless network resource system 230. The example metering, collection, and allocation system 200 is configured to meter event information on wireless devices, transmit the metered information to a central collection and processing system, analyze the metered information from a plurality of the wireless devices to generate network resource usage reports, and allocate wireless network resources based on the content within the usage reports. The collection system 102 includes an event log memory 204, a data processor 206, a data analyzer 208, and a report database 210. The metering component 104 receives event data or metered wireless device information in the form of event data 220, time-based information 222, network parametric data 224, and/or device parametric data 226.

While FIG. 2 shows an example manner of implementing the collection system 102, one or more of the functional blocks, processes and/or devices illustrated may be combined, divided, re-arranged, omitted, eliminated and/or implemented in any other way. Further, the example collection system 102 may be implemented by hardware, software, firmware and/or any combination of hardware, software and/or firmware. Thus, for example, any component of the example collection system 102 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software implementation, the collection system 102, the event log memory 204, and/or the report database 210 are hereby expressly defined to include a tangible medium such as a memory, DVD, CD, etc. Further, the collection system 102 may include one or more elements, processes and/or devices in addition to, or instead of, those illustrated in FIG. 2, and/or may include more than one of any or all of the illustrated elements, processes and devices.

In the example implementation, the metering component 104 and the collection system 102 are linked by (i.e., communicatively coupled via) a transmission medium 218. The transmission medium 218 may include, for example, the wireless links 106 as part of a traffic channel within a communication system and/or wired networks as described in connection with FIG. 1. The metering component 104 sends metered wireless device information in the form of event logs from the memory of a wireless device directly to the collection system 102 within a network over the transmission medium 218 or, alternatively, may send the metered wireless device information to a personal computer and/or network access point connected to the collection system 102 by the transmission medium 218. The metered wireless device information may be transmitted by a request to the metering component 104 from the collection system 102, at preprogrammed specified intervals, and/or at the discretion of the wireless device. For example, the metering component 104 on the wireless device may be configured to transmit the event logs to the collection system 102 every twelve hours, when the event log cache within the memory of the wireless device is full, when the wireless device is in an idle state, and/or when the panel member associated with the wireless device initiates the transfer.

The metering component 104 meters events and wireless network resource usage on a wireless device. Events include the event data 220 and the corresponding time information 222, network parametric data 224, and device parametric data 226. The event data 220 includes any data relating to activity on the wireless device initiated by a panel member. For example, the event data 220 includes usage information from data applications, device applications, metadata, and event statistics. Data applications include, for example, internet browsing, live media applications, mobile commerce transactions, mobile advertising activity, e-mail activity, etc. Device applications include, for example, games, address books, personal information management software, document processing programs, and media players used for streaming audio and video. Metadata includes attributes of device applications, for example, content title, author, date of publication, source and/or publisher information, copyright information, digital rights management information, etc. Event statistics includes, for example, voice and data call activity, text-messaging, instant messaging, etc. The time-based information 222 includes, for example, the initiation and termination time of an event, the duration of event usage, the duration of event utilization of wireless resources, and calendar data (e.g., month, week, day, hour, minute, second).

The time-based information 222 may enable the metering component 104 to follow a schedule of the time periods the metering component 104 is configured to monitor events on the wireless device. For example, a metering service, such as for example, Nielsen Mobile, may configure the metering components 104 of a plurality of wireless devices to collect metered wireless device information from 9:00 A.M. to 6:00 P.M. to ensure the data analyzer 208 has common data from the plurality of wireless devices for analysis. Additionally, the time-based information 222 may enable a metering service to determine the order in which events were accessed on a wireless device to determine usage trends between event types and network resource usage.

The network parametric data 224 includes, for example, overhead messaging data such as system parameter messages, authentication challenge messages, and service reduction messages in addition to signal quality, upload, and download speeds, carrier transmission channel frequency, signal strength, signal-to-noise ratio, channel access method, etc. The device parametric data 226 includes, for example, frame error rate, call set-up statistics (e.g., access time, call origination, and call termination) and data from hardware components of the wireless device, such as processors (mobile station modem or equivalent, global positioning system processor or equivalent, graphics processor, and other central processing units on the wireless device), volatile and non-volatile memory, receiver, transmitter, operating system, etc. In addition, the device parametric data 226 may include a clock cycle speed and/or clock cycle count of the processor and/or central processing unit of the wireless device.

The collection system 102 included within the example metering, collection, and allocation system 200 may be part of a third party metering service such as, for example, Nielsen Mobile. The event log memory 204, the data processor 206, the data analyzer 208, and the report database 210 may be communicatively coupled within the collection system 102 and/or may physically be located in multiple, separate locations and communicatively coupled together. In the illustrated example, the event log memory 204 stores event logs transmitted from one or more of the metering components 104 within wireless devices. The event logs may be arranged or organized according to panel member, device type, market area, BTS id, time period, etc.

The data processor 206 filters and process the event logs within the event log memory 204. The data processor 206 may filter event logs by wireless device type, cell area, wireless network service provider, event type, demographic information, etc. For example, the data analyzer 208 may request the data processor 206 to locate and filter event logs from wireless devices belonging to a service provider A. In that case, the data processor 206 accesses the event log memory 204 and compiles all event logs from wireless devices on the wireless network operated and owned by service provider A. The data processor 206 then sends the filtered event logs to the data analyzer 208 to calculate the wireless network resource usage from the wireless devices on network of service provider A. Additionally, the data processor 206 may delete event logs that exceed a time-to-keep parameter and/or organize the event logs within the event log memory 204 as requested by the metering service. Organizing the event log memory 204 may include counting the number of event logs, counting the number of event logs from a specific device, and/or device type, counting the number of application types and/or hardware function types, grouping similar device types, grouping event logs according to panel member, grouping event logs according to demographic information, etc. The data processor 206 may also include sorting through collected event logs to ascertain demographic profiles of panel members and related location/market information. The data processor 206 may also be configured to process event logs automatically. For example, the data processor 206 may process event logs at a specified time of the month and/or week, when the event log memory has reached a predefined fullness value, when a specified device or event sample size is reached, etc. The filtered and/or processed event logs and/or data are sent to the data analyzer 208.

The data analyzer 208 included within the collection system 102 analyzes information from the event logs and/or data sent by the data processor 206. This includes network resource usage per event type for a time period, usage statistics, service functionality, network performance metrics, device performance metrics, etc. For example, the data processor 206 may send a plurality of event logs from panel members with a specific type of wireless device to the data analyzer 208. The event logs may contain events including applications used, the length of time the applications were used, the metadata associated with the applications, the corresponding hardware functions implemented by the applications, and the network bandwidth utilized by each event. The data analyzer 208 calculates network resource usage from the compiled event logs. Network resource usage may be calculated by summing total network usage metered in the event logs. Additionally, network usage may be calculated by converting the usage time and channels to erlangs. For example, if a panel member makes a call for 30 minutes, 0.5 erlangs are consumed. Additionally, if the panel member accesses data over the wireless network for 15 minutes, 0.25 erlangs are consumed. The data analyzer 208 sums the total number of erlangs consumed per cell area, and/or BTS for a server provider to determine the total network load for the collected sample data. This value can be normalized for entire network usage to estimate the total network resource usage. For example, if the data analyzer 208 analyzes 35 event logs from wireless devices within a BTS cell area 6Y of network provider A, the data analyzer 208 can extract from the event logs the measured wireless network resource consumption of all events at a particular time period such as, for example, 2:05 PM, 5/13/2008. Summing these values provides the total network resources utilized by the metered wireless devices at 2:05 PM, 5/13/2008. Market research from the metering service may indicate the sample of wireless devices comprises 5% of the total number of wireless devices on the wireless network of service provider A in the BTS cell area 6Y. Thus the total bandwidth consumed may be the summed bandwidth from the sample of wireless devices normalized by the market size. For example, if the total bandwidth summed from the 35 event logs is 10 Mb/s, the total network bandwidth use at 2:05 PM, 5/13/2008 is estimated to be 200 Mb/s. The data analyzer 208 could continue to calculate data for subsequent time periods 2:10 PM, 5/13/2008, 2:15 PM, 5/13/2008, 2:20 PM, 5/13/2008, etc. to provide a report or graphical representation of estimated total network usage for service provider A in cell area 6Y over a plurality of time periods.

In another example, the data analyzer 208 analyzes event logs from a plurality of panel members to determine if there is a relationship between the event type and wireless network resource usage. The data analyzer 208 may analyze the order of event logs from the instance a panel member initiates an event until the panel member accesses the wireless network. An average or summary of the data can be complied to develop trends among a plurality of panel members. For example, the data analyzer 208 may determine that when panel members initiate a media player application there is a 1% probability they will access the wireless network in the next 10 minutes, a 10% probability they will access the wireless network in the next 10-20 minutes and a 50% probability they will access the wireless network in the next 20-30 minutes.

In addition to wireless network resource usage calculations, the example data analyzer 208 analyzes the event logs to determine trends in usage behavior of panel members or aggregating groups of panelists including, but not limited to, metrics such as market share of calling, web browsing, text messaging, e-mail, and secure transactions; analyzing peak/off peak usage patterns of panel members as well as average usage days per given period of time; analyzing telephony metrics including, for example, call duration, incoming versus outgoing calls, local versus long distance, calls, voicemail functions, and digital versus analog mode; analyzing wireless data/internet metrics including, for example, reach (percentage of users who visit a particular website during a given time period), unique visitors (number of web-active individuals who visited a particular website or web property within a given time frame), top sites or URLs visited during a given period of time, top sites bookmarked, counts of secure transactions placed during a given time period, visits to non-web digital media sites over a given period of time, click streams, advertisement views and responses; analyzing functionality of various wireless voice, and data/internet services provided to users whereby number of hits per site or application versus total offerings may provide such indication; analyzing performance metrics related to the device including, but not limited to, keypad operation, CPU processing capabilities, RF calibration, transmit and receive power; and analyzing performance metrics related to the operators' networks including, but not limited to, RSSI (received signal strength indication), access failures, finger assignments, handoff and decoder activity, transmit and receive power, frame error rates, dropped calls, block calls, connection speeds, internet or web applications download speeds, and secure transaction speeds.

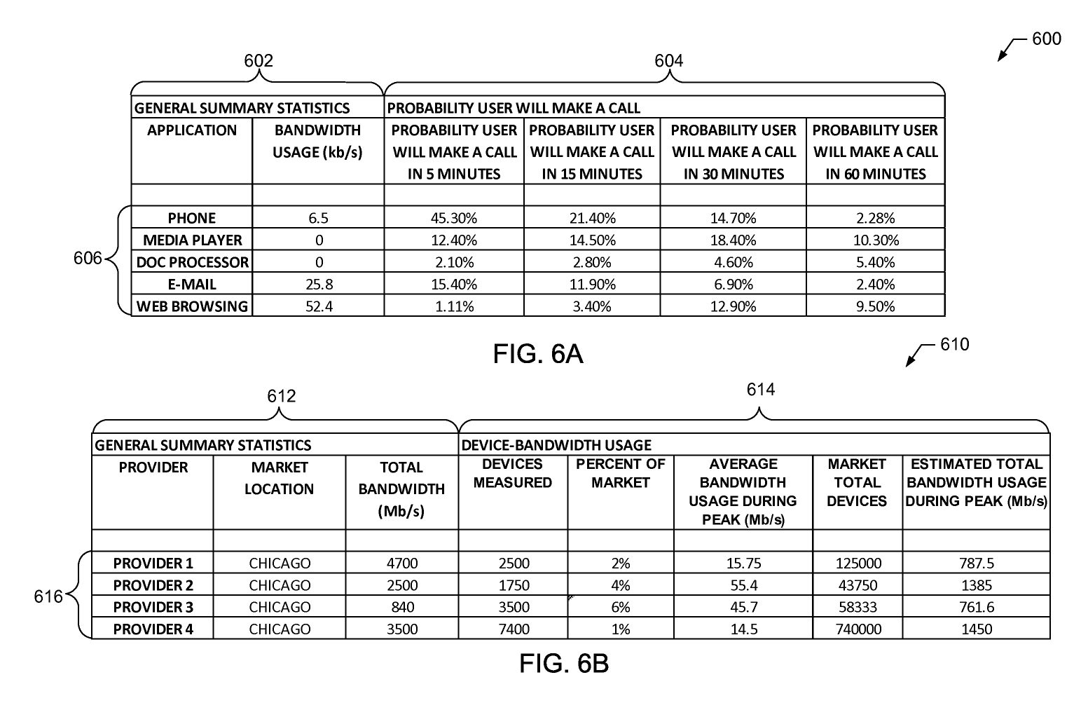

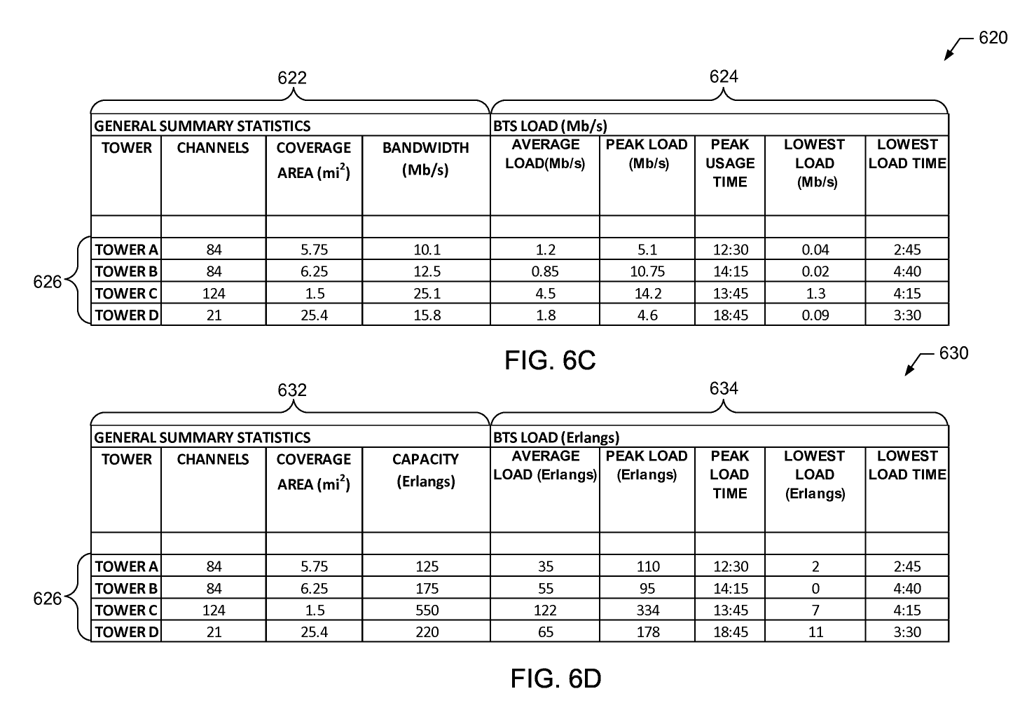

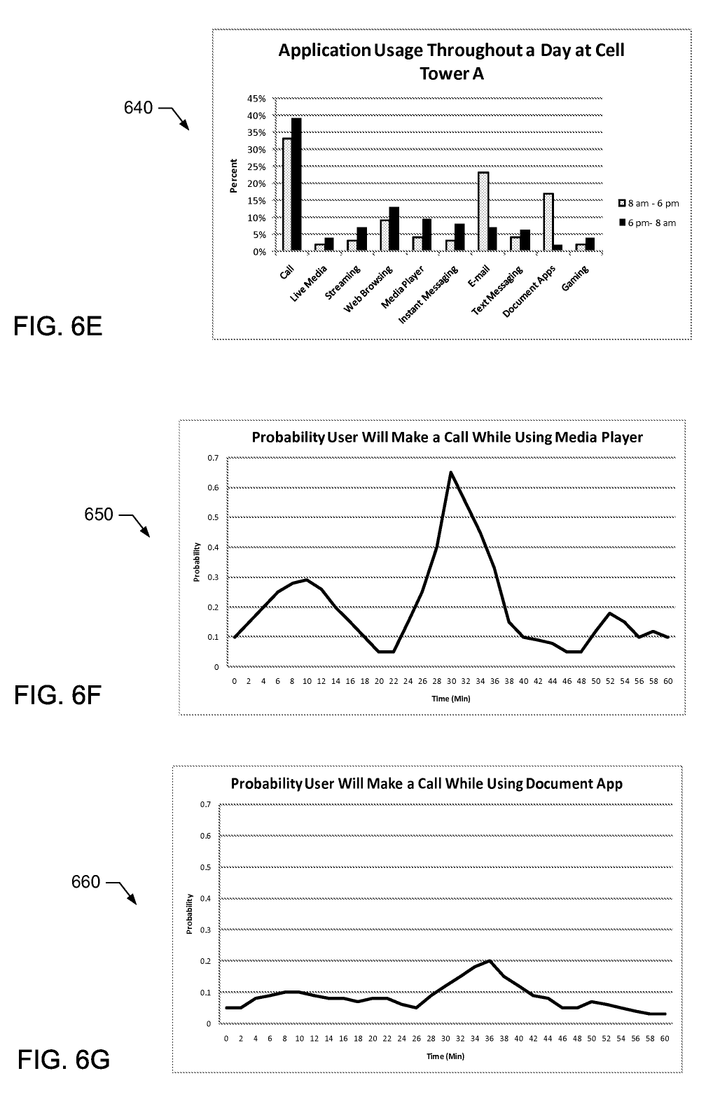

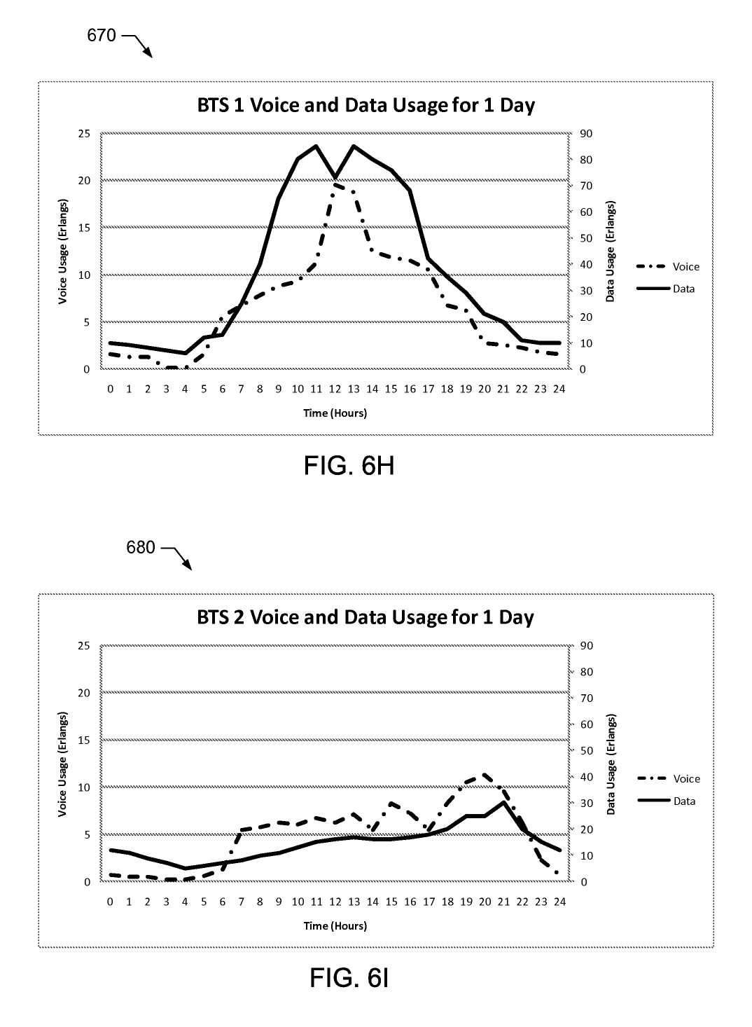

The report database 210 included within the collection system 102 of FIG. 2 stores calculated data from the data analyzer 208. The report database 210 may additionally use the calculated data to generate reports 228 that can be used for marketing information products, including the probability a wireless device user will access the network upon initiating an event, total metered wireless device bandwidth usage, estimated total wireless device bandwidth usage, bandwidth usage per BTS, application use types per wireless devices, traffic channel usage per BTS per time of day, traffic channel usage per BTS per day of week and/or month, application usage per demographic type, bandwidth usage per application type, bandwidth usage per wireless device type, bandwidth usage per market type, bandwidth usage per demographic type, etc. The marketing products and/or reports 228 may be automatically generated by the report database 210 upon receipt of calculated data from the data analyzer 208. Additionally or alternatively, the reports 228 may be generated by a prompt from the metering service. Examples of marketing reports are described in further detail below in conjunction with FIGS. 6A-6I.

The reports 228 may be sent directly to wireless network providers, wireless network operators, consumers, application developers, wireless device manufacturers, interested third parties, etc. The reports 228 within the example metering, collection, and allocation system 200 are forwarded to the wireless network resource system 230. The reports 228 may be forwarded electronically in the form of machine readable coded data for an electronic medium to process, and/or in an electronic and/or hardcopy form in readable text and/or graphical representations.

The wireless network resource system 230 receives the reports 228 generated by the collection system 102 and adjusts and/or allocates wireless network resources based on the data within the reports 228. In this example, the network resources include network bandwidth 232, BTS cell coverage area 234, the number of carrier frequency channels 236, and number of BTS transceivers 238. In other example implementations, wireless network resources may additionally include BTS transceiver transmission power, frequency separation between carrier frequency channels, number of timeslots per radio frequency channel, number of directional antennas per base station, bandwidth per carrier frequency channel, antenna beamwidth, etc. The wireless network resource system 230 may be part of a service provider wireless network or, alternatively, may be included within and/or controlled by a metering service. Upon receiving the reports 228, the system may modify network resource allocation based on the predictive information in the reports 228. The wireless network resource system 230 may modify the allocation of wireless network resources through network control devices such as, for example, a MSC, a Packet Control Unit (PCU), and/or a BSC. Additionally, the wireless network resource system 230 may modify network resources by physically moving, relocating, adding, or deleting wireless network resources including the number of transceivers within a BTS, the number of directional antennas within a BTS, the locations of BTSs within a communication system, the capacity of a BTS, etc.

In an example implementation, a report 228 indicates that within a service provider's wireless network communication system, BTS 6Y experiences an estimated annual peak load of 235 erlangs with an average daily load of 143 erlangs, while adjacent BTS 6Z experiences an estimated annual peak load of 436 erlangs with an average daily load of 230 erlangs. The wireless network service provider compares this information to its current allocation of network resources where BTS 6Y is allocated 600 erlangs, while BTS 6Z is allocated 250 erlangs. In this example the network service provider's wireless network resource system 230 could reduce the BTS cell coverage area 234 of BTS 6Z and increase the BTS cell coverage area 234 of BTS 6Y to shift more of the network load to 6Y. Alternatively, to create a more efficient communication system the network bandwidth 232 of BTS 6Z can be increased, while the network bandwidth 232 of BTS 6Y is decreased, thereby increasing the number of traffic channels (i.e., erlangs) allocated to BTS 6Z while decreasing the number of traffic channels allocated to BTS 6Y.

In another example, the reports 228 indicate a wireless device user has an 80% probability of accessing the wireless network within 5 minutes of initiating a text messaging application. The wireless network resource system 230 may ping wireless devices requesting a response when a text messaging application is initiated. Then, when the wireless network resource system 230 receives a response indicating a text messaging application has been initiated within the BTS 6Y cell area, the wireless network resource system 230 can check with the BTS 6Y to ensure there is an available traffic channel to handle the anticipated network usage from the wireless device that initiated the text messaging application.

In yet another example, the reports 228 may indicate BTS 6Y experiences peak network loads from 1:00 PM-5:00 PM every day, while an adjacent BTS 6Z experiences peak network loads from 6:00 PM until 9:00 PM. The wireless network resource system 230 may allocate network resource such that more network bandwidth 232 and carrier frequency channels 236 are allocated to BTS 6Y from 1:00 PM-5:00 PM while from 6:00 PM until 9:00 PM more of the network bandwidth 232 and carrier frequency channels 236 are allocated to BTS 6Z.

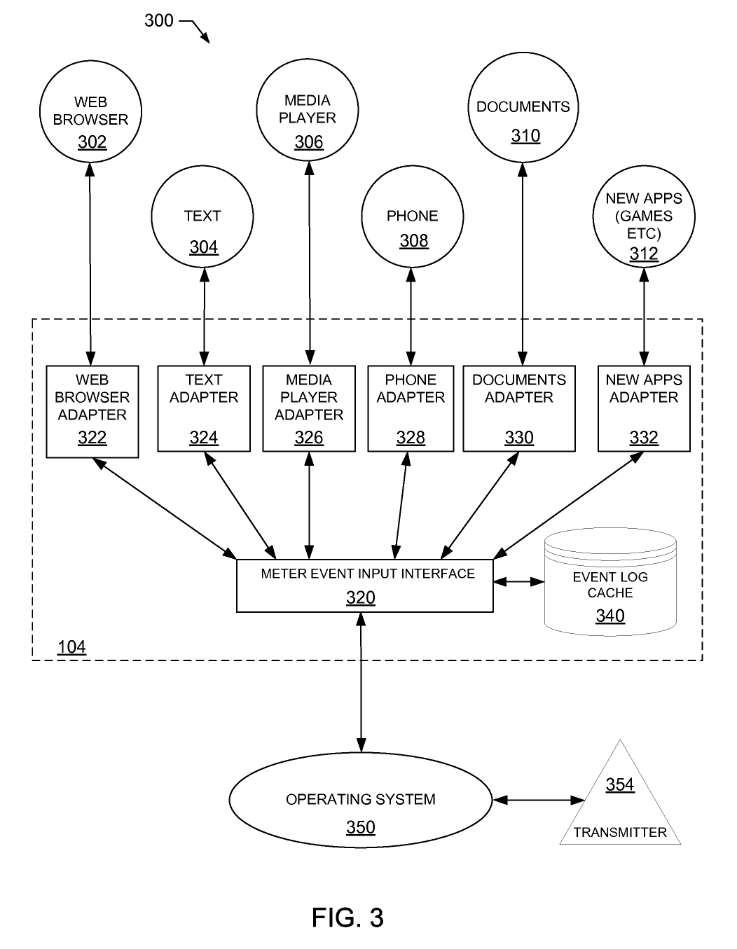

FIG. 3 shows a functional block diagram of an example wireless device 300, including the metering component 104 of FIG. 1, applications 302-312, an operating system 350, an event log cache 340, and a transmitter 354. The metering component 104 includes application adapters 322-332, a meter event input interface 320, and the event log cache 340. The metering component 104 may be stored within the wireless device 300 on a software medium, within a memory medium accessed by the operating system 350, embedded within a ROM and/or operating system, and/or included within a metering hardware component, such as an ASIC, installed during the manufacture of the wireless device 300.

While FIG. 3 shows an example manner of implementing the metering component 104, one or more of the functional blocks, processes and/or devices illustrated in FIG. 3 may be combined, divided, re-arranged, omitted, eliminated and/or implemented in any other way. Further, the example metering component 104 may be implemented by hardware, software, firmware and/or any combination of hardware, software and/or firmware. Thus, for example, any component of the example metering component 104 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software implementation, the metering component 104, the event log cache 340, and/or the meter event input interface 320 are hereby expressly defined to include a tangible medium such as a memory, DVD, CD, etc. The metering component 104 may include one or more elements, processes and/or devices in addition to, or instead of, those illustrated in FIG. 3, and/or may include more than one of any or all of the illustrated elements, processes and devices.

In the example implementation of FIG. 3, the metering component 104 is located within the wireless device 300. Alternatively, in other example implementations, the metering component 104 may be exterior to or remotely located relative to the wireless device 300, but communicatively coupled to the wireless device 300. In this example, the metering component 104 can be attached to the wireless device 300 and/or included within a personal computer communicatively coupled to the wireless device. Further, the metering component 104 can be configured for each type of wireless device. For example, wireless cellular devices with a SET A of applications may receive metering component A, wireless cellular devices with a SET B of applications may receive metering component B, while wireless laptops with a SET C of applications may receive metering component C. Alternatively, the metering component 104 may configure itself during installation within the wireless device 300. For example, during installation, the metering component 104 may determine the number and types of applications on a wireless device and configure the corresponding application adapters.

The application adapters 322-332 included within the metering component 104 are configured to monitor the corresponding application (e.g., event) without causing a deviation or degradation in performance of the monitored application. The application adapters 322-332 are initiated when the corresponding application is opened by a panel member on the wireless device 300. The application adapters 322-332 monitor and capture events and their corresponding attributes, including wireless network resource use, by polling the applications for metering information, and/or inspecting application files, and/or application software code for metering information. For example, the web browser adapter 322 monitors the instances a panel member launches the web browser, the web sites visited, the duration of using the web browser, the upload data transfer speed, the download data transfer speed, corresponding BTS identification, data transfer time, carrier frequency channel, and the duration at each site. The example wireless device 300 shows six applications 302-312 and corresponding application adapters 322-332. However, alternative wireless devices may include more or fewer applications and corresponding application adapters. The applications may include any of the applications described above in conjunction with FIG. 2.

In an alternative implementation, one or more of the applications 302-312 may be configured to report metered event information directly to the meter event input interface 320, as described in U.S. Pat. No. 6,353,929 which is hereby incorporated by reference in its entirety. Application developers may cooperate with a metering service, such as Nielsen Mobile, to incorporate metering components within an application. In this example, the metering component 104 does not need application adapters to monitor and collect the information from the applications because the applications provide the metered information. For example, a media player may be configured to report metadata, usage time, and/or device parametric data such as, for example, volume, tone, clock cycles, and/or file format to the meter event input interface 320.

The meter event input interface 320 receives the metered information from the application adapters 322-332 and organizes the data into event logs. Example structures of the event logs are described in further detail in conjunction with FIGS. 5A-5J. The meter event input interface 320 saves the event logs to the event log cache 340. The meter event input interface 320 collects and organizes the information at the end of a metered event. Alternatively, the application adapters 322-332 may send the metered wireless device information during the metered event. Additionally, the meter event input interface 320 requests collected information from the application adapters 322-332. In the example, the application adapters 322-332 continuously monitor the applications and the meter event input interface 320 collects information from the application adapters 322-332. In another example implementation, the application adapters 322-332 collect data during specific time periods dictated by the metering component 104. Outside of this time period, the application adapters 322-332 may remain in an off state.

In cases where the application adapters 322-332 do not send network resource usage information, the meter event input interface 320 meters the wireless device operating system 350 and/or any other hardware and/or software components that may include device and/or network parametric data. For example, the phone application adapter 328 may only send the meter event input interface 320 the call time and the number called. The meter event input interface 320 may meter the operating system 350, wireless integrated circuit, receiver and/or transmitter for information such as, for example, the BTS identification, the carrier frequency channel, the signal strength, the signal quality, the digital voice transmission (e.g., upload) speed, the digital voice reception speed (e.g., download), signal multiplexing type (e.g., TDMA), network provider type, etc. The meter event input interface 320 then combines the network and/or device parametric data with the phone adapter 328 metered data into a single event log for the event.

In the example implementation, the meter event input interface 320 collects event use information from the application adapters 322-332. The initiation of an event generates the creation of a new event log corresponding to the initiated event. The event logs are configured to contain information associated with the event. The termination of the event subsequently ends with the meter event input interface 320 storing metered data to the corresponding event log. In other example implementations, an event log may include data from one or more events in use during a time period.

The event log cache 340 receives and stores event logs from the meter event input interface 320. The event log cache 340 stores the event logs until the event logs are transmitted to the collection system 102. The event log cache 340 may be a part of the RAM and/or any other memory component of the wireless device 300. Additionally, the event log cache 340 may be a separate memory chip installed during manufacture of the wireless device 300. In other example implementations the event log cache 340 may be exterior to the wireless device 300, such as in a wireless memory device (e.g., an SD card), or within a personal computer communicatively coupled to the wireless device 300.

The operating system 350 included within the wireless device 300 manages the operation of the wireless device 300. This includes hosting the applications 302-312, interacting between the applications 302-312 and hardware components, ordering event processing on a processor, saving event information to memory, coordinating data transfer from I/O devices, and/or operating the meter event input interface 320 in the background of the applications 302-312. Additionally, the meter event input interface 320 collects information from the operating system 350, including the number of clock cycles needed to run an application, parametric device information, etc. In the example, the meter event input interface 320 sends the event logs from the event log cache 340 to the operating system 350 and the operating system 350 sends the event logs to the transmitter 354 for transmission to the collection system 102.

The transmitter 354 included within the wireless device 300 enables the transfer of event logs to the collection system 102. The transmitter 354 may be an integrated circuit and antenna configured to transmit data wirelessly. The transmitter 354 may adhere to the wireless standards described in FIG. 1. Alternatively, the transmitter 354 may be a driver such as for example, a USB driver to transmit data via a hardwired medium to a personal computer.

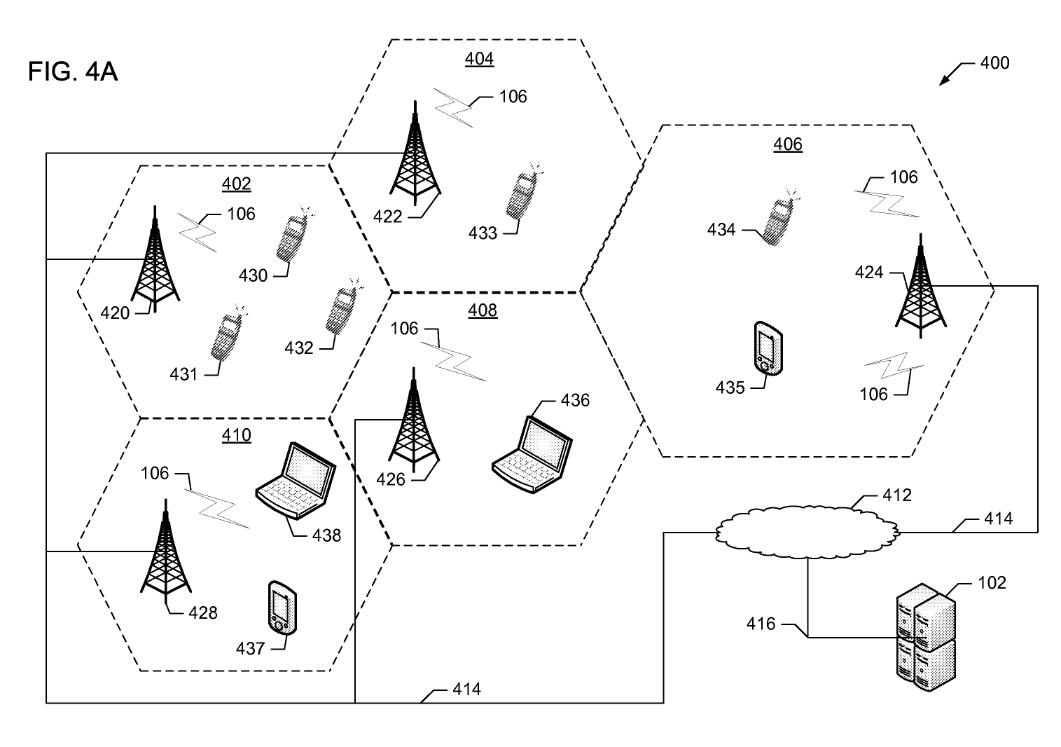

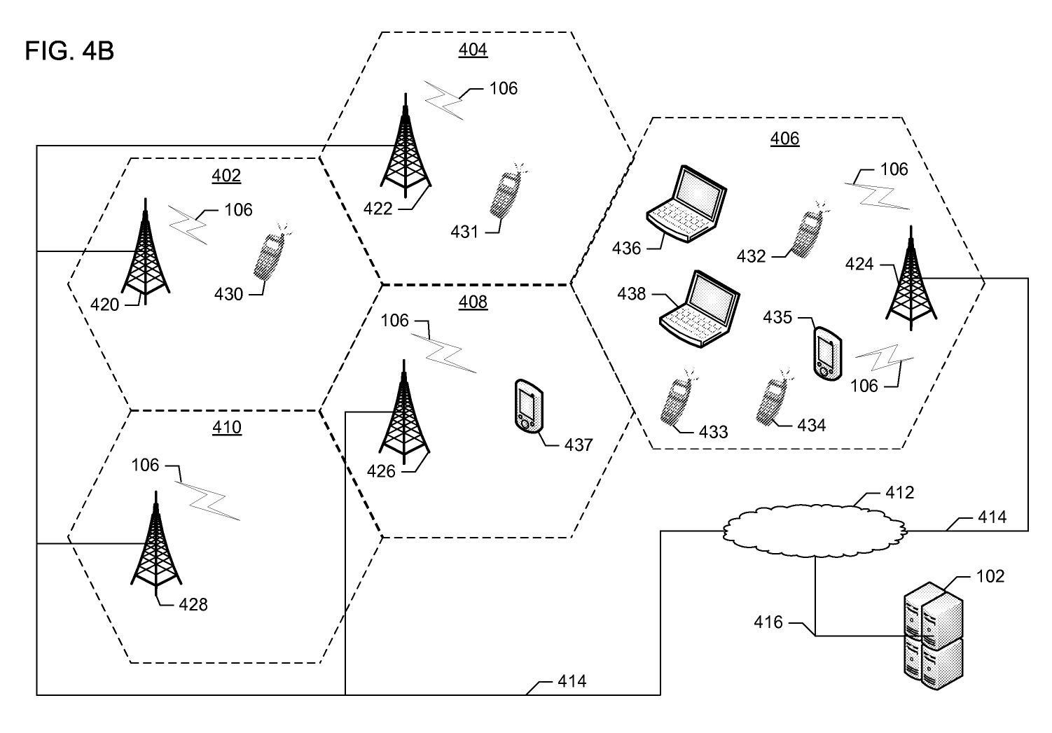

FIG. 4A shows an example communication system 400 at a time period T1 of a wireless network operated and/or controlled by a wireless service provider 412 including BTSs 420-428 within respective cell areas 402-410. The cell areas 402-410 include wireless links 106 between the respective BTSs 420-428 and wireless devices 430-438. The BTSs 402-410 are communicatively coupled to the wireless network provider 412 by a communication circuit 414. Additionally, the collection system 102 of FIGS. 1 and 2 is communicatively coupled to the wireless network provider 412 by a network link 416.

The communication system 400 of FIG. 4 at time period T1 shows wireless devices 430-432 within the cell area 402 serviced by the BTS 420, wireless device 433 within the cell area 404 serviced by the BTS 422, wireless devices 434 and 435 within the cell area 406 serviced by the BTS 424, wireless device 436 within the cell area 408 serviced by the BTS 426, and wireless devices 437 and 438 within the cell area 410 serviced by the BTS 410. The cell areas 402-410 may contain additional wireless devices and/or wireless device types. At any time period, one or more of the wireless devices 430-438 may access the wireless network 412. The wireless devices 430-438 may move anywhere within their respective cell areas and remain in communication with the respective BTS. The metering component 104 within each of the wireless devices 430-438 meters the events on the wireless device including the utilization of the wireless network resources by the event.

In this example, the wireless devices 430-438 are all accessing the wireless network via the wireless links 106. Each of the wireless devices 430-438 has a respective wireless link 106 to its respective BTS. Alternatively, the wireless devices within the same cell area may share a wireless link 106 such that each wireless device communicates within a timeslot of a carrier frequency channel (e.g., using a TDMA communication scheme). For example, the wireless devices 430-432 may communicate with the BTS 402 via the wireless link 106, where the wireless link 106 is a carrier frequency channel that contains 8 timeslots. Thus, the three wireless devices 430-432 each utilize one of the eight timeslots on the carrier frequency channel.

The example communication system 400 provides wireless data and/or communication services (e.g., telephone services, Internet services, data services, messaging services, instant messaging services, electronic mail (email) services, chat services, video services, audio services, gaming services, etc.) over a geographic area. The cell areas 402-410 are arranged in a pattern and/or grid with abutting and/or overlapping coverage areas such that any of the wireless devices 430-438 located in and/or moving through and/or within the communication system 400 are communicatively covered by one or more of the plurality cell areas 402-410. The BTSs 420-428 provide wireless data and/or communication services to any number and/or type(s) of wireless, mobile, fixed-location and/or substantially fixed-location devices currently located within the respective cell areas including the wireless devices 430-438. The wireless devices 430-438 may include a personal digital assistant (PDA), an audio player, a wireless telephone (e.g., a cellular phone, a voice over Internet Protocol (VoIP) phone, a smart phone, etc.), a laptop computer with wireless communication capabilities (e.g., including a wireless modem card), etc, a wireless gaming system, a text messaging machine, etc.

The example BTSs 420-428 and/or the example wireless devices 430-438 may be, for example, implemented to modulate and transmit reference and/or data and/or control signals and/or symbols in accordance with one or more past, present and/or future wired and/or wireless communication standards and/or specifications, such as the Evolved Universal Terrestrial Radio Access (EUTRA) specification currently being defined by Third Generation Partnership Project (3GPP) Technical Study Group (TSP) Radio Access Networks (RAN) Working Group 1 (WG1). However, the wireless devices 430-438 may be implemented to modulate and transmit reference and/or data and/or control signals and/or symbols in accordance with any additional and/or alternative past, present and/or future technology(-ies), standard(s) and/or specification(s) such as, for example, the Institute of Electrical and Electronics Engineers (IEEE) 802.11x family of standards, wideband code division multiple access (WCDMA), time division multiple access (TDMA), frequency division multiple access (FDMA) and/or any combination thereof. The wireless links 106 may operate on any type of wireless network and may include traffic channels as part of a wireless communication system. For example, a circuit switched network, a paging network, and/or packet data networks including, but not limited to, AMPS, CDMA, GSM, iDEN, GPRS, ODFM, 3XRTT, 3GSM, LTE, EDGE, WiMax, etc.

The BTSs 420-428 include equipment for transmitting and receiving radio signals, including transceivers and antennas, and equipment for encrypting and decrypting communications with a Base Station Controller (BSC). The transceivers enable the BTSs 420-428 to serve several different frequencies and different sectors of the respective cell areas 402-410. The BTSs 420-428 are controlled by a parent BSC (not shown). This BSC allocates radio channels, receives measurements from the wireless devices 430-438, and controls handovers from BTS to BTS. The parent BSC acts as a concentrator where many different low capacity connections to the BTSs 420-428 become reduced to a smaller number of connections towards a Mobile Switching Center (MSC). In other words, the networks are often structured to have many BSCs distributed into regions near their BTSs, which are then connected to a large centralized MSC site within the wireless network provider 412. The BSC is a full switching center and an SS7 node with connections to the MSC. Additionally the BSC provides the required data to an Operation Support Subsystem as well as to the performance measuring centers within the wireless network provider 412. The databases for the cell areas 402-410 are stored in the BSC and may include information such as carrier frequencies, frequency hopping lists, power reduction levels, and/or receiving levels for cell border calculation. This information is obtained from the wireless network provider 412. The BTSs 420-428 are communicatively coupled to the BSCs and MSC within the wireless network provider 412 by a communication circuit 414. The communication circuit 414 may include an A-bis protocol, which is carried by a DS-1, ES-1, and/or E1 TDM circuit using TDM subchannels for network traffic, Link Access Procedures on the D channel for BTS supervision and telecom signaling, and for synchronization between the BSC and BTSs 420-428.

The collection system 102 is communicatively coupled to the wireless network provider 412 by the network link 416. The network link 416 enables data transfer (e.g., the transfer of metered wireless device information) between the wireless devices 430-438 and the collection system 102. The network link 416 may, for example, be a wired or wireless telephone network, a cable network, a satellite network, a utility (e.g., electrical service) network, etc to the wireless network provider 412.

The wireless devices 430-438 contain the metering component 104. The metering component 104 manages the transmission of metered event information and wireless network resource usage data from the wireless devices 430-438 to the collection system 102. The event logs are transmitted from the wireless devices 430-438 to the BTSs 420-428 which, in turn, transmit the event logs to respective BSCs which, in turn, transmit the event logs to MSCs within the wireless network provider 412. The MSCs may then route the data to the IP address corresponding to the location of the collection system 102.

FIG. 4B shows the example communication system 400 of FIG. 4A at a time period T2 of the wireless network operated and/or controlled by the wireless service provider 412. Time period T2 shows some of the wireless devices 430-438 have moved to different cell areas 402-410 from time period T1. For example, the wireless device 431 moved to the cell area 404, the wireless devices 432-436 and 438 have moved to the cell area 406, and the wireless device 437 has moved to cell area 408. The movement of the wireless devices 430-438 shows an example of how wireless network resource usage may shift between the cell areas 402-410 from one time period to the next within a wireless communication system.

The metering component 104 within the metered wireless devices 430-438 stores BTS identification information enabling a metering service to determine the number of wireless devices serviced by a BTS over a plurality of time periods. When collected, processed, and analyzed by the collection system 102, the wireless network provider 412 may use the predictive wireless network resource usage data to dynamically allocate wireless network resources from time period T1 to time period T2. This includes increasing the bandwidth at BTS 424 while decreasing the bandwidth at the BTSs 428, 422 and 426. Alternatively, the wireless network provider 412 may reduce the coverage area of the BTS 424 while increasing the coverage areas of the adjacent BTSs 404 and 408. If the network load in time period T2 remained constant for weeks and/or months, the wireless network provider 412 could divide the cell area 406 into smaller cell areas served by respective BTSs.

FIGS. 5A-5J show tables of example event logs 500-590, each of which includes an event field 592, a first attribute field 594, a second attribute field 596, and a description field 598. The event logs 500-590 store event information and the corresponding wireless network resource usage on a wireless device. The example event logs 500-590 are shown in an example structure. Additionally or alternatively, the event logs 500-590 may be configured in a hierarchical structure, a tree structure, and/or any other data organization structure. The metering component 104 of FIG. 1 may include the example event logs 500-590. In an alternative implementation, the metering component 104 may contain a single event log configured to store event information for any type of application, event, and/or hardware component. In another implementation, the event logs 500-590 may be configured by the metering component 104 upon installation within a wireless device. For example, upon installation, the metering component 104 may poll the event types within the wireless device and create default event logs for each of the event types. The format for each event type may be preprogrammed and/or preconfigured within the metering component 104 by the metering service. When an event is initiated on a wireless device the metering component 104 copies the corresponding event log type (e.g., web browsing, media player, etc.) and saves the event information to the new event log.

The event logs 500-590 are configured for a single application type. For example, the call event log 500 is configured for a phone application including attributes for time of the call, duration of the call, the phone number called, the signal strength and call quality of the wireless link 106 to the BTS, the service provider network code, the BTS identification, the transceiver cell identification, channel frequency, and bandwidth allocated for the call. In additional example event logs, the event log 510 is configured for text messaging applications, the event log 520 is configured for e-mail applications, the event log 530 is configured for instant messaging applications, the event log 540 is configured for web browsing applications, the event log 550 is configured for media player applications, the event log 560 is configured for document processing applications, the event log 570 is configured for data streaming applications, the event log 580 is configured for live media applications, and the event log 590 is configured for gaming applications. In other implementations the event logs 500-590 may contain more or fewer attributes. The metering component 104 may include additional event logs for applications and/or events not mentioned in the example implementation.

The event logs 500-590 are configured with the event field 592 to store an event identifier value and the event type, the first attribute field 594 to store data associated with information within the event field 592, the second attribute field 596 to store additional data associated with a field within the first attribute field 594, and the description field 598. The description field 598 provides a summary of possible values for the first attribute field 594 and/or the second attribute field 596. The description field 598 is non-functional, and is only displayed for information purposes. In alternative example implementations, the event logs 500-590 may contain additional fields and/or additional field types.

Each event log includes a unique event identifier. This enables event logs to be searchable by the EVENT ID value. Additionally, the event identifier assigned to an event log is stored in the NEXT EVENT ID field of the previous event log. For example, the metering component 104 may store metering information from a media application within an event log with an EVENT ID field of MP003. The media player application is then terminated and subsequently at some later time a web browsing application is the next initiated event. A copy of the web browsing event log 540 is made and the new event log is given a new event identifier value of WB023, which is stored in the EVENT ID field. Additionally, the WB023 value is stored in the NEXT EVENT ID field of the MP003 event log. This enables the data processor 206 and/or data analyzer 208 within the collection system 102 of FIG. 2 to analyze and determine trends in event usage and subsequent wireless network resource usage.

FIGS. 6A-6I show example wireless network resource usage reports. FIGS. 6A-6D are tables of example wireless network resource usage reports 600, 610, 620 and 630. The wireless network resource usage reports 600, 610, 620 and 630 may be constructed by the report database 210 of FIG. 2 from the calculated data from the data analyzer 208 and include a summary statistics section, and a results section. The summary statistics section contains general information including device type, total number of devices per device type metered, and the average measured energy use per device over a two hour time period. In another example, the summary statistics section may include additional information, including network service provider, panel member demographic information, etc.

The network resource usage report 600 of FIG. 6A includes a summary statistics section 602 and a results section 604. The network resource usage report 600 shows the predicted probability a user will make a call within a time period upon initiating an application on a wireless device. The summary statistics section 602 includes application types 606, and the corresponding measured average bandwidth usage per application type. The results section 604 includes the predicted probability a user will make a call. In other example reports, the results section 604 may include the probability of accessing the wireless network.

In the example of FIG. 6A, a media player on a wireless device is shown not to utilize network resources when functioning. The results section 604 shows that after initiating the media player application, a user has a predicted 12.40% probability of making a call using the wireless device within the next 5 minutes, a 14.50% probability of making a call in 15 minutes, an 18.40% probability of making a call in 30 minutes, and a 10.30% probability of making a call in 60 minutes. The network resource usage report 600 may be used by a wireless network provider to help predict wireless network usage. The wireless network provider could add a function to wireless devices so that the wireless devices ping the wireless network anytime an event is initiated. The wireless network provider would use the ping to check current wireless network availability to ensure the wireless device will have available bandwidth and/or an available traffic channel at the time period the predicted probability indicates there is a likely chance the wireless device will attempt to access the wireless network. Additionally or alternatively, wireless network providers may use the date to predict total network loads. In many cases, wireless network providers may recognize that the wireless network includes excess unused capacity that has a low probability of being accessed by all the wireless devices within the cell area at any one time. This could help the wireless network providers reduce the excess capacity to create a more efficient communication system.

The network resource usage report 610 of FIG. 6B includes a summary statistics section 612 and a results section 614. The network resource usage report 610 shows the measured and estimated bandwidth usage during the peak time period for four different wireless network providers in the Chicago market. The summary statistics section 612 includes wireless network provider types 616, the market location of the metering, and the corresponding measured total bandwidth allocated to the market. The results section 614 includes number of wireless devices metered, the market or population sampling percentage, average bandwidth used during the peak time period for the provider, and an estimate of the total number of wireless devices and bandwidth usage for the entire market. The estimated total number of devices and total bandwidth usage are derived from the sampling percentages of the market population.

The network resource usage report 620 of FIG. 6C includes a summary statistics section 622 and a results section 624. The network resource usage report 620 shows the measured average, peak and low load levels for four different BTS towers within a wireless network expressed in terms of bandwidth (Mb/s). The summary statistics section 622 includes wireless network BTS towers 626, the number of channels allocated to the BTS towers, the coverage area of the BTS towers, and the corresponding total bandwidth allocated to the BTS tower estimated for the entire cell area of each BTS tower from the metered sample data. The results section 624 includes the average wireless network load, the peak load, lowest measured load and corresponding times of the day the peak and low loads occurred for each BTS tower. The corresponding wireless network provider may use the network resource usage report 620 to allocate wireless network resources between the wireless network BTS towers 626. For example, TOWER B experiences a peak load capacity of 86%. In other words, of the allocated bandwidth of 12.5 Mb/s, on average a maximum of 10.75 Mb/s is consumed around 2:15 P.M. every day. Tower C experiences a higher peak load of 14.2 Mb/s, but only utilizes 56% of the wireless network resources allocated (i.e., bandwidth) for TOWER C. The wireless network provider may use the report to shift wireless network resources from TOWER C to TOWER B to compensate for the higher percentage of network capacity used at TOWER B during the peak usage time. In another example, the wireless network provider may compare the utilized bandwidth to the allocated bandwidth for each tower and increase bandwidth in cases QoS levels are threatened by too little wireless network capacity, or decrease bandwidth in cases a BTS tower has excess capacity.

The network resource usage report 630 of FIG. 6D includes a summary statistics section 632 and a results section 634. The network resource usage report 630 is similar to the network resource usage report 630 of FIG. 6C and shows the measured average, peak and low load levels for four different BTS towers within a wireless network. However, the network resource usage report 630 expressed network usage in terms of erlangs. The summary statistics section 632 includes the wireless network BTS towers 626, the number of channels allocated to the BTS towers, the coverage area of the BTS towers, and the corresponding total bandwidth allocated to the BTS tower estimated for the entire cell area of each BTS tower from the metered sample data. The results section 634 includes the average wireless network load, the peak load, lowest measured load and corresponding times of the day the peak and low loads occurred for each BTS tower. The network resource usage report 630 is expressed in erlangs to highlight the capacity of a BTS tower during average, peak, and low traffic loads. The network resource usage report 630 may additionally compare BTS tower capacity to predicted usage to predict QoS levels during peak traffic loads.

FIGS. 6E-6I are graphs of example wireless network resource usage reports 640, 650, 660, 670, and 680. The wireless network resource usage reports 640, 650, 660, 670, and 680 may be constructed by the report database 210 of FIG. 2 from the calculated data from the data analyzer 208. The network resource usage report 640 of FIG. 6E shows the application usage over two time periods on a group of wireless devices within BTS TOWER A. The application usage is measured as a percentage of total usage. The information shows a wireless network provider the types and the amount of each type of metered applications used for two time periods. The wireless network provider could use the information to allocate more wireless network resources for calls from 6 PM-8 PM and more wireless network resources for e-mail from 8 AM-6 PM.

The network resource usage report 650 of FIG. 6F shows the predicted probability a user will make a call while using a media player application. The network resource usage report 660 of FIG. 6G shows the predicted probability a user will make a call while using a document processing application. The x-axis is the time in minutes from the initiation of the application and the y-axis is the probability of the phone application being initiated. A wireless network provider could use the report to predict the wireless network resource usage of a BTS knowing the current states of wireless devices in the corresponding cell area and the associated predicted probability those wireless devices will access the wireless network in the near future.

The network resource usage report 670 of FIG. 6H shows the wireless network resource usage for a BTS 1 over the course of a 24 hour time period. The network resource usage report 680 of FIG. 61 shows the wireless network resource usage for a BTS 2 over the course of a 24 hour time period. The network resource usage reports 670 and 680 are divided between wireless network resource usage for making calls and wireless network resource usage for data applications. Both sets of data are expressed in terms of the number of erlangs utilized within the BTS. In other words, the number of traffic channels used within the BTS over the course of an hour. For example, in the network resource usage report 670, less than 5 erlangs are used for voice and data applications and/or events in the first 6 hours. Then from hours 6 to 12 network traffic peaks and then tapers off from hours 14 to 24. In the network resource usage report 680, network recourse usage remains constant throughout much of the day except from hours 17-21 in which a 12-13 erlang peak occurs. A wireless network provider could use the network resource usage reports 670 and 680 to adjust allocations of wireless network resources between BTS 1 and BTS 2 such that more resources are provided to TOWER 1 from hour 7 through hour 17, while some resources are shifted from BTS 1 to BTS 2 from hours 17 through 22. Additionally, the wireless network provider may see the need to provide more channels allocated for data then voice in BTS 1.

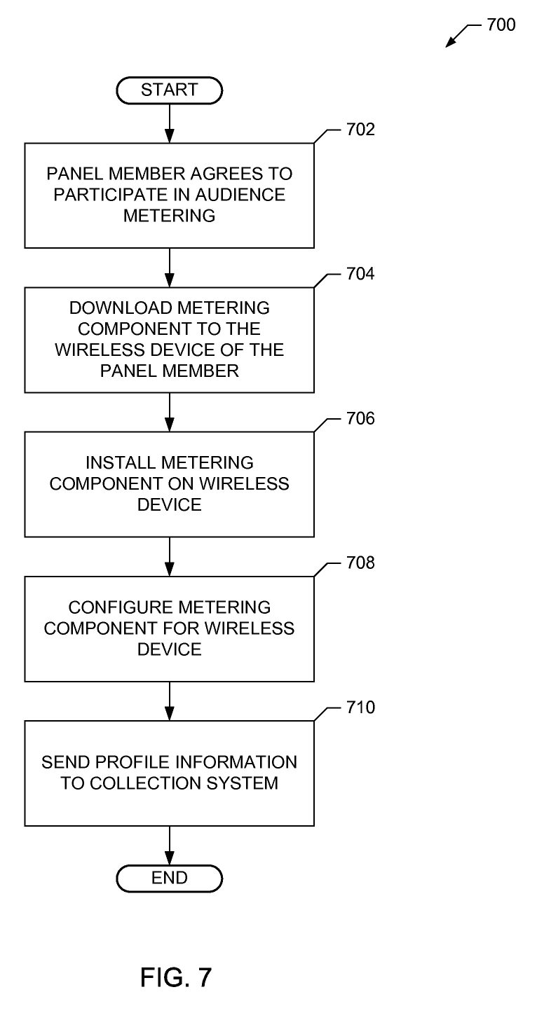

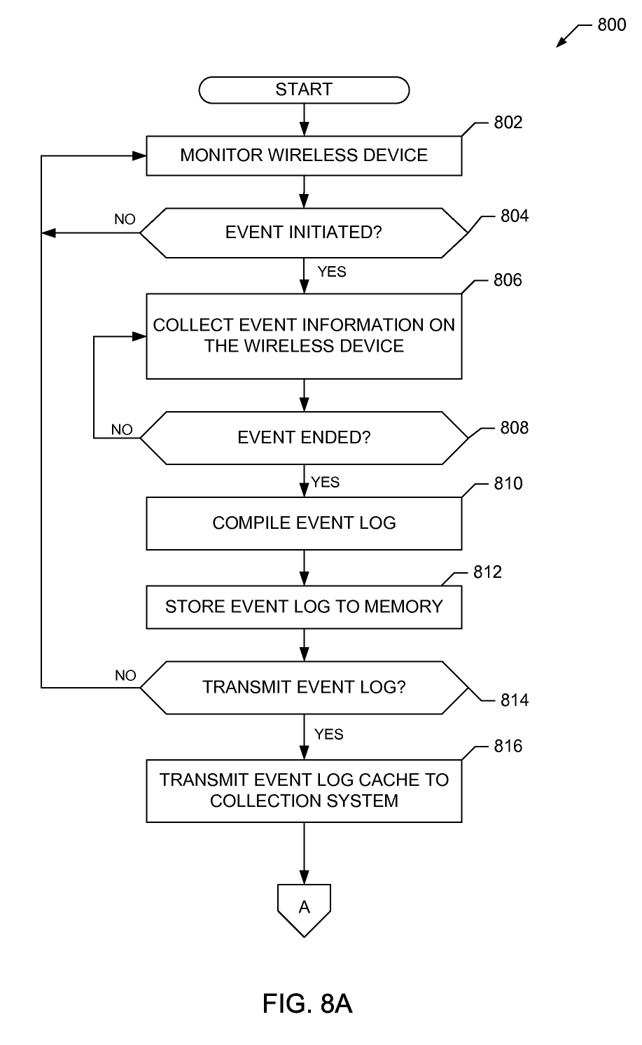

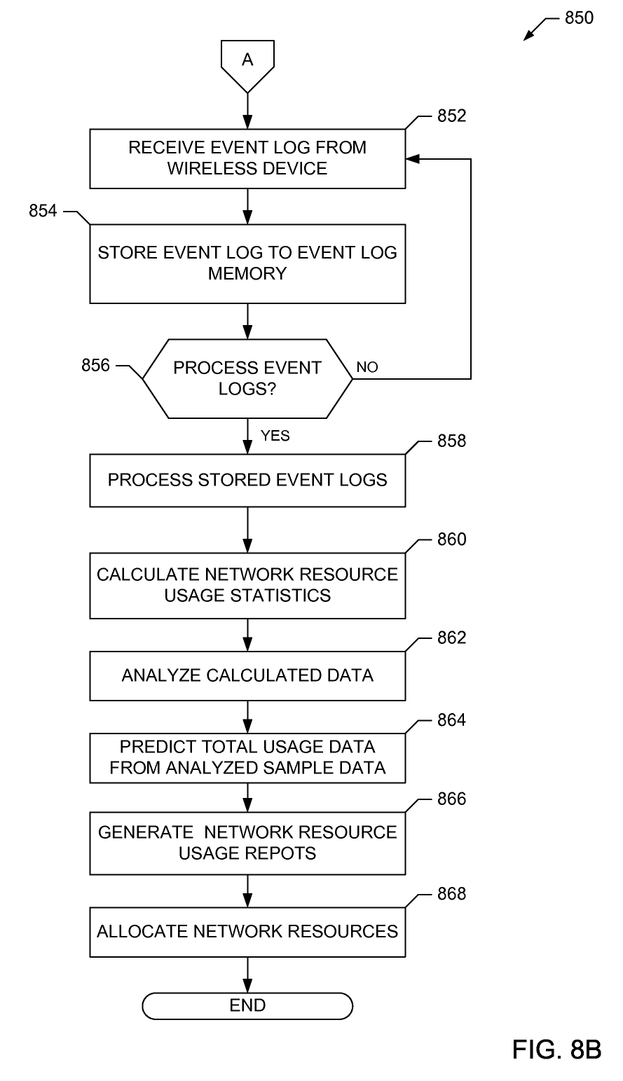

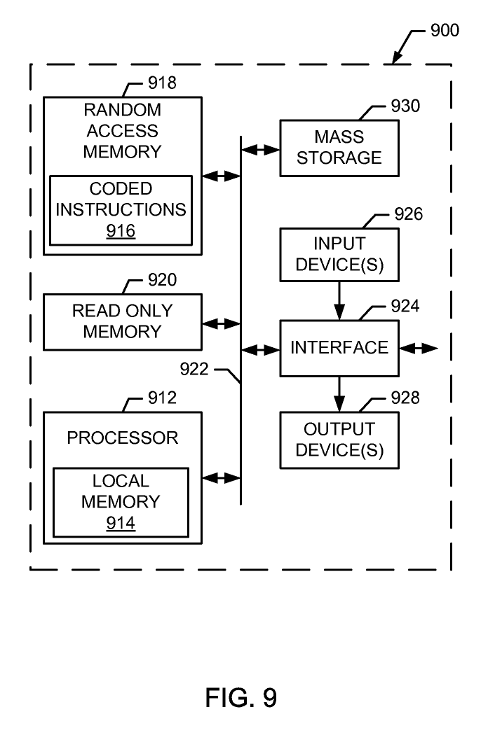

FIGS. 7, 8A, and 8B are flowcharts representative of example methods or processes that may be performed to meter and analyze wireless network resource usage data and event information within a sample of wireless devices to predict wireless network resource usage. The example methods may be implemented using machine readable instructions, code, software, etc. that is executed using, for example, a processor system such as the system 900 of FIG. 9. However, the one or more of the blocks depicted in the flowcharts may be implemented in any other manner, including dedicated purpose circuitry, manual operations, etc. Additionally, although the example methods are described with reference to the flowcharts of FIGS. 7, 8A, and 8B other methods to meter and analyze wireless network usage data and event information within wireless devices to predict wireless network resource usage may additionally or alternatively be used. For example, the order of execution of the blocks depicted in the flowcharts of FIGS. 7, 8A, and 8B may be changed, and/or some of the blocks described may be rearranged, eliminated, or combined.

In particular, example method 700 of FIG. 7 may be performed to implement the example metering component 104 and/or the collection system 102 of FIGS. 1-3. The example method 700 may be executed at predetermined intervals, based on an occurrence of a predetermined event, etc., or any combination thereof. For example, the method 700 may be executed in a wireless device including the metering component 104 and/or within the collection system 102, at predetermined intervals, such as hourly, daily, etc. Additionally or alternatively, the example method 700 may be executed upon the occurrence of a trigger generated remotely such as, for example, on a wireless device when a panel member registers and/or agrees to download and/or install the metering component 104.

The method 700 begins at block 702 when a panel member registers and/or agrees to participate in the metering of wireless network resource usage and events on their wireless device. The panel member may register by visiting the metering service website to enter the wireless device and/or demographic information, may respond to a solicited and/or unsolicited communication from the metering service asking the panel member to participate in the metering survey, and/or a panel member may agree to a request from a preinstalled metering component 104 that prompts the panel member to participate in the metering survey. Registering may also include the panel member indicating the type, make, revision, and/or model of their wireless device so that the corresponding metering component 104 may be installed. Once the panel member agrees to have their wireless device metered, control proceeds to block 704 where the metering component 104 is downloaded to and installed on the wireless device. This may also include manually attaching the metering component 104 to the wireless device. Then, in block 706, the metering component 104 is installed onto the wireless device (e.g., via a memory stick). This includes the wireless device running an installation program associated with the metering component. Additionally or alternatively, this may include installing any hardware components of the metering component 104 within the wireless device.

Control then proceeds to block 708 where the metering component 104 is configured within the wireless device. This includes setting up one or more application adapters and/or device parametric meters for the corresponding applications and/or hardware components within the wireless device, creating connections between the application adapters and/or hardware component meters to the meter event input interface 320, allocating and/or creating space within the device memory for the event log cache 340, polling applications and/or hardware components for metering capability, etc. In another example, the configuration may include configuring the metering component 104 to relay metered information to a personal computer. Once the metering component 104 had been configured, control proceeds to block 710 where the metering component 104 sends profile information to the collection system 102. This may include the identification information of the wireless device, including a model and serial number, market region, the type of applications and/or events the metering component 104 is configured to meter, panel member demographic information, etc. Once the collection system has received the profile information from the metering component, the method 700 for installation and configuration of the metering component 104 ends.

Example methods 800 and 850 of FIGS. 8A-8B may be performed to implement the example wireless network resource system 230 of FIG. 3 and the example metering component 104 and/or the collection system 102 of FIGS. 1-3. The example methods 800 and 850 may be executed at predetermined intervals, based on an occurrence of a predetermined event, etc., or any combination thereof. For example, the method 800 may be executed in a wireless device including the metering component 104, while method 850 may be executed within the collection system 102 at predetermined intervals, such as hourly, daily, etc. Additionally or alternatively, the example method 800 may be executed upon the occurrence of a trigger generated remotely such as, for example, on a wireless device when the metering component 104 is initiated. Similarly, the example method 850 may be executed upon the occurrence of a trigger generated remotely such as, for example, on the collection system 102 when event logs are transmitted from one or more wireless devices.

The method 800 begins at block 802 when a metering component 104 begins to monitor a wireless device. Control remains in block 802 until an event is initiated on the wireless device (block 804). In an alternative implementation, the metering component 104 may start a new time period and begin metering events only for the duration of the time period. The indication to start a new time period may be received by the metering component 104 from the collection server 102 and/or the schedule of time periods may be included within software instructions for the metering component 104. Upon the initiation of the event in block 804, control proceeds to block 806 where the metering component 104 collects event information on the wireless device. This includes application information gathered by the application adapters, device parametric and network parametric data from hardware and/or software components, and/or direct metering information from the applications and/or hardware. The collection of event information initiates upon the activation of an event and does not end until the event is terminated. For example, the metering component 104 may be collecting metering information regarding a media player while a panel member launches a web browser application and an e-mail application. For each new event initiated, a new instance of block 804 is initiated.

In block 808, the meter event input interface 320 within the metering component 104 polls the application adapters to determine if the event has terminated. If the event has not terminated, control returns to block 806 to continue collecting metering information. If the event has terminated, control proceeds to block 810 where the event information collected by the application adapters is configured by the meter event input interface 320 into an event log. In another example implementation, the meter event input interface 320 continuously collects and stores event information from the application adapters until the event is terminated, at which point the application adapters cease to send new metering information associated with the terminated event. In yet another implementation, the application adapters collect event information until the termination of the event. Then in block 810, the event information is sent to the meter event input interface 320 to be compiled with wireless network resource data that may not have been part of the data collected by the application adapters. In addition to collecting metering information from the application adapters, the meter event input interface 320 collects device parametric data and network parametric data corresponding to the metered event from hardware and/or software components within the wireless device. The device parametric data and network parametric data includes network resource usage by the event. The meter event input interface 320 compiles the collected metered event information and network resource usage data into an event log corresponding to the metered event.

After the event information has been added to the event log, block 812 is executed where the event log is stored to the event log cache 340 of FIG. 3. The event log contains all the event information and network resource usage data prior to storing within the event log cache 340. In an alternative implementation, the event log may not be stored to the event log cache 340 until a metering time period has expired.

Next, in block 814, the metering component 104 determines if the event logs within the event log cache 340 should be transmitted to the collection system 102. If it is not time to transmit the event logs, control returns to block 802 where the metering component 104 monitors the wireless device and waits for the initiation of the next event. If the event logs are to be transmitted to the collection system 102, block 816 is executed. In block 816, the event logs within the event log cache 340 are transmitted to the collection system 102. The metering component 104 may have a preprogrammed schedule detailing the times to transmit the event logs. Alternatively, the event logs may be transmitted when the event log cache 340 has reached a certain capacity. In another example implementation, the collection system 102 may request the event logs from the metering component 104. In yet another example, the event logs may be transmitted when the wireless device is in an idle state. The event logs may be transmitted wirelessly through a service provider network to the collection system 102 or, alternatively, through a personal computer with a wired connection to a network.

The method 850 begins at block 852 where the collection system 102 receives an event log from a wireless device (block 852). Upon each instance of the collection system 102 receiving an event log, a new block 852 may be initiated. Once the collection system 102 receives an event log, the received event log is stored to the event log memory 204 (block 854). Once the event log is stored, the collection system 102 checks if the event logs within the event log memory 204 should be processed (block 856). If the event logs are not yet to be processed, control returns to block 852 and the collection system 102 waits for another event log. If the event logs are to be processed control passes to block 858. The decision to process the event logs may come from the metering service. Alternatively, conditions may be defined within the collection system 102 to specify when event logs are processed such as, for example, every Sunday at 8:00 P.M. and/or when the event log memory 204 reaches a certain capacity.

In block 858, the event processor 206 within the collection system 102 processes the event logs. This may include filtering the event logs for calculations and/or organizing the event logs. Then, the processed event logs are analyzed by the data analyzer 208 to calculate wireless network resource usage statistics (block 860). This may include summing, averaging, and/or differentiating total network resource usage per BTS per time period, the total metered wireless device bandwidth usage per market area, the number of metered erlangs per BTS over a time period, wireless network resource usage per event type, wireless network resource usage per demographic type, wireless network resource usage per device type, and/or calculating average wireless network resource usage per panel member. Upon completion of the calculations, the data and event logs are analyzed (862). The analysis is performed to determine trends in wireless network resource usage from the sample data in order to predict total wireless network usage trends. Analysis may include determining the probability a wireless device user will access the network upon initiating an event, traffic channel usage per BTS per time of day, traffic channel usage per BTS per day of week and/or month, application usage per demographic type, and/or device parametric QoS information such as, for example, network quality, wireless device quality, network data transfer speed, the probability a BTS will be too busy to receive a call or new request for network access, and/or wireless network resource usage per event type. Then in block 864 the calculated and analyzed data is structured into a predictive model to estimate and predict wireless network resource usage for an entire communication system from the sample data collected in the event logs. This includes expanding the calculated and analyzed data by the percentage of panel members within the entire population per BTS cell area, market area, and/or communication system area. This may also include predicting total wireless device bandwidth usage, total peak and low traffic loads per BTS per time period, total market share of wireless network resources, total market share of wireless network usage, etc.

Next in block 866, the data calculated in block 860, analyzed in block 862 and predicted in block 864 is structured into a report format in the report database 210. The reports may include the network usage per time period for a wireless service provider, peak and load wireless network loads per BTS, bandwidth usage per demographic type, market share for device types, market share for network usage, market share for applications, wireless network resource usage per event type, the types of applications and/or hardware functions used per wireless device, the metadata associated with the applications, device parametric information, market share information, etc. Once the reports are generated, control proceeds to block 868 where the wireless network resource system 230 of one or more wireless network service providers allocated network resources based on information within the reports. This includes modifying bandwidth per BTS, number of transceivers and directional antennas per BTS, BTS coverage area, number of carrier frequency channels, bandwidth per carrier frequency channel, location of BTSs, etc. Additionally or alternatively, the wireless network resource system 230 may view the generated reports and decide to not modify wireless network resource allocations. Once the reports are generated by the collection system 102 and considered for allocation of network resources within the wireless network resource system 230, the example method 850 ends.

FIG. 9 is a block diagram of an example computer system 900 capable of implementing the system and methods disclosed herein. The computer 900 can be, for example, a server, a personal computer, a personal digital assistant (PDA), an internet appliance, a DVD player, a CD player, a digital video recorder, a personal video recorder, a set top box, or any other type of computing device. Any or all of the example metering component 104, the collection system 102, the example data processor 206, the example event log memory 204, the example data analyzer 208, the example report database 210, the wireless network resource system 230, and/or the example processor on the wireless devices 110-122 may be implemented in and/or implemented by the example computer 900.

The system 900 of the illustrated example includes a processor 912 such as a general purpose programmable processor. The processor 912 includes a local memory 914, and executes coded instructions 916 present in the local memory 914 and/or in another memory device. The processor 912 may execute, among other things, machine readable instructions to perform the processes or methods represented in FIGS. 7, 8A, and/or 8B. The processor 912 may be any type of processing unit, such as one or more microprocessors from the Intel® Centrino® family of microprocessors, the Intel® Pentium® family of microprocessors, the Intel® Itanium® family of microprocessors, the Intel® Core® family of microprocessors, and/or the Intel® XScale® family of processors. Of course, other processors from other families are also appropriate.

The processor 912 is in communication with a main memory including a volatile memory 918 and a non-volatile memory 920 via a bus 922. The volatile memory 918 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 920 may be implemented by flash memory and/or any other desired type of memory device. Access to the main memory 918, 920 is typically controlled by a memory controller (not shown) in a conventional manner.

The computer 900 also includes a conventional interface circuit 924. The interface circuit 924 may be implemented by any type of well known interface standard, such as an Ethernet interface, a universal serial bus (USB), and/or a third generation input/output (3GIO) interface.

One or more input devices 926 are connected to the interface circuit 924. The input device(s) 926 permit a user to enter data and commands into the processor 912. The input device(s) can be implemented by, for example, a keyboard, a mouse, a touchscreen, a track-pad, a trackball, an isopoint and/or a voice recognition system.

One or more output devices 928 are also connected to the interface circuit 924. The output devices 928 can be implemented, for example, by display devices (e.g., a liquid crystal display, a cathode ray tube display (CRT)), by a printer and/or by speakers. The interface circuit 924, thus, typically includes a graphics driver card.

The interface circuit 924 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 900 also includes one or more mass storage devices 930 for storing software and data. Examples of such mass storage devices 930 include floppy disk drives, hard drive disks, compact disk drives and digital versatile disk (DVD) drives. The mass storage devices 930 may implement any or all of the metering components 104, event log cache 340, event log memory 204, the report database 210, and/or the collection system 102. Additionally or alternatively, the volatile memory 918 may implement any or all of the metering components 104, event log cache 340, event log memory 204, the report database 210, and/or the collection system 102

At least some of the above described example methods and/or system are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or system described herein, either in whole or in part. Furthermore, alternative software implementations including, but not limited to, distributed processing or component/object distributed processing, parallel processing, or virtual machine processing can also be constructed to implement the example methods and/or system described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

Additionally, although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, system and articles of manufacture have been described herein, the scope of coverage of this patent is not limited thereto. On the contrary, this patent covers all methods, system, and articles of manufacture fairly falling within the scope of the appended claims either literally or under the doctrine of equivalents.

1. A method to predict the use of wireless network resources from usage data of wireless devices, the method comprising:
receiving data related to a user interaction with a wireless device in an offline mode;
analyzing the received data to predict wireless network resource usage of the wireless device; and
outputting information associated with the predicted wireless network resource usage of the wireless device for use in allocating wireless network resources.

2. The method as defined in claim 1, wherein the received data includes a plurality of separate events.

3. The method as defined in claim 2, wherein each event comprises a plurality of data attributes including at least one of an application name, an application type, a time an application was launched, an application description, a time an application was terminated, a physical location of the wireless device where an application was launched, or the network resource required for an application.

4. The method as defined in claim 1, further comprising processing and storing the received data on a collection system.

5-6. (canceled)

7. The method as defined in claim 1, further comprising analyzing the received data to predict wireless network resource usage of a plurality of wireless devices.

8. The method as defined in claim 1, further comprising:
monitoring the user interaction with the wireless device;
collecting data related to the user interaction with the wireless device; and
transmitting the collected data to a collection system.

9-10. (canceled)

11. The method as defined in claim 8, wherein collecting the data comprises collecting the data via a metering software operating on the wireless device.

12. The method as defined in claim 1, wherein the received data comprises device specific information.

13. The method as defined in claim 12, wherein the device specific information comprises at least one of a model number, a manufacturer, an operating system, a subscriber name, a version number or a device identification number.

14. The method as defined in claim 1, wherein the received data further comprises information regarding a performance of the wireless device.

15. The method as defined in claim 14, wherein the performance of the wireless device comprises at least one of a signal strength, a signal interference, a signal quality, a speed of download/upload, or an amount of detected signal error.

16. The method as defined in claim 1, wherein analyzing the received data comprises processing the received data to determine wireless network resource usage statistics.

17. The method as defined in claim 16, wherein the wireless network resource usage statistics comprise at least one of an amount of wireless network resource usage per location for a time period, an amount of wireless network resource usage per application, an amount of wireless network resource usage per application per location for a time period, an amount of wireless network resource usage per wireless device for a time period, or an amount of wireless network resource usage per wireless device per location.

18. The method as defined in claim 1, wherein analyzing the received data further comprises processing the received data to determine wireless network quality statistics.

19. The method as defined in claim 18, the wherein wireless network quality statistics comprise a quality of wireless network resource usage per location for a time period, a quality of wireless network resource usage per application, a quality of wireless network resource usage per application per location for a time period, a quality of wireless network resource usage per wireless device for a time period, or a quality of wireless network resource usage per wireless device per location.

20. The method as defined in claim 1, wherein analyzing the received data comprises processing the received data to determine wireless network resource usage demographic statistics.

21. The method as defined in claim 20, wherein the wireless network resource usage demographic statistics comprise at least one of an amount of wireless network resource usage per location per demographic for a time period, an amount of wireless network resource usage per application per demographic, an amount of wireless network resource usage per application per location per demographic for a time period, an amount of wireless network resource usage per wireless device per demographic for a time period, or an amount of wireless network resource usage per wireless device per location per demographic.

22. The method as defined in claim 1, wherein analyzing the received data comprises determining a probability one or more wireless devices will access the wireless network resources within a time period.

23. (canceled)

24. The method as defined in claim 1, wherein outputting the information associated with the predicted wireless network resource usage comprises reporting the information to a wireless network service provider that allocates wireless network resources based on the information.

25-29. (canceled)

30. A system to predict the use of wireless network resources from usage data of wireless devices, the system comprising:
a collection system to receive data related to a user interaction with a wireless device in an offline mode; and
a prediction system to analyze the data and predict wireless network resource usage of a wireless device.

31. The system as defined in claim 30, further comprising:
a transmission system to transmit the received data to the collection system; and
a wireless device containing metering software to monitor and store data related to a user interaction with the wireless device.

32-33. (canceled)

34. The system as defined in claim 31, wherein the metering software is configured to collect a plurality of separate events.

35. (canceled)

36. The system as defined in claim 31, wherein the metering software is configured to collect device specific information.

37. (canceled)

38. The system as defined in claim 31, wherein the metering software is configured to collect information regarding a performance of the wireless device.

39. (canceled)

40. The system as defined in claim 30, wherein the wireless device includes one or more applications.

41. (canceled)

42. The system as defined in claim 30, wherein the prediction system is to analyze and predict wireless network resource usage of a plurality of wireless devices.

43. The system, as defined in claim 30, wherein the collection system is part of a wireless service provider network.

44. The system as defined in claim 30, wherein the collection system is the property of a third party and is to communicate with the wireless device through a wireless service provider network.

45. The system as defined in claim 30, wherein the collection system is configured to analyze the collected data to determine wireless network resource usage statistics, wireless network quality statistics, wireless network resource usage demographic statistics, or a probability one or more wireless devices will access the wireless network resources within a time period.

46. The system as defined in claim 30, further comprising a reporting system to generate reports including predicted network resource usage of one or more wireless devices to allocate the wireless network resources.

47. (canceled)

48. A machine readable medium having instructions stored thereon that, when executed, cause a machine to:
receive and store data related to a user interaction with a wireless device in an offline mode on a collection system;
analyze the received data to predict wireless network resource usage of the wireless device; and
output information associated with the predicted wireless network resource usage of the wireless device for use in allocating wireless network resources.

49-66. (canceled)
